(19) United States
(12) Patent Application Publication
(10) Pub. No.: US 2015/0186913 A1
(43) Pub. Date: Jul. 2, 2015

(54) TRACKER-MEDIATED MOBILE IN-APP CONTENTREDEMPTION SYSTEM FOR APP ADVERTISERS OVER THE INTERNET

(71) Applicant: Kankado Cellular Solutions Ltd., Yokneam (IL)

(72) Inventors: Sagi MANN, Rishon Lezion (IL); Guy HOLLENDER, Ra'anana (IL)

(21) Appl. No.: 14/492,203

(22) Filed: Sep. 22, 2014

Related U.S. Application Data
(60) Provisional application No. 62/018,681, filed on Jun. 30, 2014.
(60) Provisional application No. 61/922,809, filed on Jan. 1, 2014.

(51) Int. Cl. G06Q 30/02

(52) U.S. Cl. CPC G06Q 30/0219; G06Q 30/0225

(57) ABSTRACT

Computer-implemented offer redemption process including receiving notification from supported trackers, each having a different known configuration, to enable each supported tracker to pass field/s, specific to the configuration, in which an ID of a content offer is stored. The offer is defined as a quantity of a currency, to an advertiser having an account, upon app installation. Responsively to receipt of notification, offer id and/or advertiser account is validated using field/s in which offer's ID is stored. If validated, processor is used for redeeming the offer including generating and storing a voucher with unique voucher ID on computer storage medium, passing voucher ID, user/device id, app identifier, and currency and quantity to advertiser such that advertiser can enable the quantity of the currency in an app identified by the app identifier, for the user/device. Generated voucher is marked “redeemed” to prevent recurring redemption.

### REFERENCE TO CO-PENDING APPLICATIONS

Priority is claimed from U.S. provisional application No. 61/922,809, filed 1 Jan. 2014 and entitled “Virtual content promotion for application advertisers over the Internet” and from U.S. Ser. No. 62/018,681, filed 30 Jun. 2014 and entitled <<Tracker-mitigated mobile in-app content redemption system for app advertisers over the Internet>>.

### FIELD OF THIS DISCLOSURE

The present invention relates generally to apps and more particularly to platforms for advertisers.

### BACKGROUND FOR THIS DISCLOSURE

Nowadays, an advertiser of an app who wishes to acquire users for his app, may do so using electronic advertisements which include creatives (images, video, etc) in various sizes and a link to invoke when the user “accepts” the ad e.g. by clicking or tapping. Electronic ads are distributed through publisher partners, which ensure end users are exposed to such creatives and can respond thereto by downloading the promoted app. Some links are “app activation links”, e.g. from trackers, that directly open an app, assuming the app exists, rather than taking the user to a download page. These links may also be distributed as part of ads that specifically target “existing users” of that app.

MobileAppTracking.com, Appsflyer.com, Adjust.io, AdxTracking.com, Chartboost, Flurry, Inmobi, Google Play built-in Tracking are examples of mobile tracking platforms (also termed herein “trackers” and “tracking providers”) which may support mobile operating systems and/or mobile web, such as iOS, Android, Amazon and Windows Phone 8, and/or development platforms such as Adobe Air Extensions, Titanium, Phonegap, Unity, and may be integrated with various acquisition channels such as ad networks, social networks, publishers, exchanges, DSPs. Each platform typically enables its users (e.g. developers) to identify the most effective acquisition source. An SDK integration may be used to provide reporting to advertisers, including metrics (data) such as: installs, post-install attribution, engagement, retention, ROI (return on investment) and LTV (lifetime value) per source. A real-time dashboard may be provided to allow mobile advertisers to measure media sources, including viral and social sources so as to optimize mobile app promotional campaigns.

Trackers are operative for tracking the source of the installation of an app and the app's context. Once an app is installed, trackers determine which publisher the user came through, and what contextual information was accumulated by the publisher including tracking re-directions among a plurality of publishers and providing the advertiser with analytic reports, showing each publisher's performance in bringing in users.

E-content publishers include mobile advertising publishers with which mobile tracking platforms “partner” such as, for example, Facebook, GoogleAdwords, AdColony, Applift, NativeX, InMobi, PlayHaven, Tapjoy, Millennial Media, and Drawbridge.

State of the art digital advertisement technologies are described in the following patent documents inter alia: US20140073410; WO2002033622A1; US20030004802; US20130013389; U.S. Pat. No. 7,735,726; WO2013006719A2; and US20130013383.

FreeGameCredits.com (FGC) is a website which has “teamed up with . . . apps to give you a bunch of Free Game Credits”. The website states that “users are rewarded with your currency, they are longer immersed with your content and your community which results in a higher engagement”. The website states that it partners with KOCHAVA, a mobile tracking service, to provide app-FGC integration. The developer gets “control over the releasing of credits to users”.

The disclosures of all publications and patent documents mentioned in the specification, and of the publications and patent documents cited therein directly or indirectly, are hereby incorporated by reference. Materiality of such publications and patent documents to patentability is not conceded.

### FIELD OF THE INVENTION

The invention is in the field of digital advertising technology generally, such as mobile advertising.

### SUMMARY OF THE DISCLOSURE

The following terms may be construed either in accordance with any definition thereof appearing in the prior art literature or in accordance with the specification, or as follows:

Accept: a process whereby an end-user indicates, e.g. by clicking or tapping on an ad, that s/he wants to redeem a content offer presented to to end-users via any of a population of e-content publishers.
Advertiser: computerized entity which provides an individual, organization, company or agency, that is the owner of Content Offers.
API, Application Programming Interface which specifies how software components are to interact with each other.
App aka Application: a software product users may explicitly download and install, such as a game on a mobile device; or use without an explicit need to download and install, such as a game available on a website. An app may have its components distributed across a plurality of computers or devices, such as a combination of a mobile phone and a server.
App Tracking URL=App Download URL: a URL which eventually leads an end user to an App's download screen, such as but not limited to a link to an App store URL or a some other URL that redirects to the App store URL (sometimes referred to as a tracking URL or a redirection URL).
Content Offer: an offer, made to an end user, that defines Content being offered to a user, the app in which the content is being offered (e.g. such as “1 unlocked level in an App called Hotwired”), and, optionally, other data characterizing the offer such as definitions of limits to be checked during validation, and definitions of anonymity.
Anonymity: whether the system is allowed to maintain per-end user or per-device usage history of this offer. If No, the system is allowed to do so. If Yes, the system is not allowed to do so and typically avoids storing any per-end user or per-device usage history, as well as disabling content offer features related thereto.
Supported Platforms: various software platforms supported by the invention, including but not limited to iOS, Android, Adobe Air, Unity, Corona, Marmelade, Windows Mobile, Facebook, Playscape, Appcelerator Titanium, Blackberry, HTML, JavaScript, PHP, Java, ASP.NET, Python, Ruby.
“App Activation link aka Activation link, deep link” link e.g. URL that directly activates an existing app which does not work for an app that is not already installed. Activation links are used, for example, to share one Waze user's location with a second Waze user. When the second user clicks on the “activation” link in Waze, the second user's Waze automatically opens with the route corresponding to the “activation link”, already in place. Also termed (by Apple) App Custom URL, (by Google) Intent with URI scheme. “in-app content” or “Virtual Content” or Content: a virtual commodity or virtual asset (also termed herein “content item”), such as but not limited to character power-up that increases end-user strength n-fold, a piece of a treasure map or other clue on how to complete a quest goal within the app, a bonus or difficulty level that is normally locked unless bought or earned
In-app content has value to a user of an app (e.g. game) because the app recognizes this content, typically expressed in terms of app virtual currency (e.g. points, swords, levels, gold coins) and responsively, entitles the user to a desired improvement in the user's state within the app. Content is typically expressed as units of currency which are recognized by the app, such as “levels”, or a number n of virtual objects like swords, rockets and coins.
Enable: allowing an-end user to access in-app content in exchange for a voucher the end-user has presented for redemption.
End User Identity aka Device Identity aka User/Device Identifier: a plurality of bits that uniquely identify an end user or the computer/device he currently uses to the system shown and described herein. In the mobile world, such an identity is usually provided by the operating systems: IDFA (“ID for advertisers”) by iOS, GAID (“Google Advertiser ID”) or ANDROID_ID by Android, MAC address by most operating systems, an email address, a Facebook User ID, and so on.
Notification URL: URL of advertiser's server that is to receive, from the tracker, a notification of each install/reopen of an app. Notification URLs typically fire after the app is installed/reopened and not at click time.
Programmer: It is appreciated that the term programmer as used herein may practically speaking refer to an advertiser employee whose job description is, say, marketing manager rather than “programmer”. Typically, a programmer with the former job description may perform the offer definition of FIG. 2 and those portions of the app definition process that does not require programming knowledge e.g. first step 9-1 of FIG. 9, while the latter will be responsible for carrying out tasks that require technical know-how such as steps 9-4, 9-5 of FIG. 9.
Publisher: an individual, organization, company or agency, that is the owner of visual ad space, where visual advertisement or Content Offers may be displayed to an end user.
Publishing Partner or Ad Network: an individual, organization, company or agency, that handles promotion tasks for Advertisers (usually for a price), such as obtaining the right ad space from Publishers in order to promote the Advertiser's Apps; reporting various promotion parameters to the Advertisers to track performance of this promotions, e.g. as per Wikipedia's entry on [Advertising Network, Wikipedia].
Redemption or “withdrawal”: the process of exchanging a voucher for the in-app content that an End User is entitled to according to the voucher.
SDK, Software Developer Kit: typically a set of software development tools that allows for the creation of applications for a certain software package, software framework, hardware platform, computer system, video game console, operating system, or similar development platform.
Tracking Provider: a computerized entity n individual, organization, company or agency, that provides each of a population of advertisers with App Tracking URLs and auxiliary services to manage those URLs and analyze their activity. It is possible to track URLs, such that one URL from one Tracking Provider leads to another URL from another Tracking Provider, which would eventually lead to the app's download page or some other app page via App Activation Links.
Validation: using a processor to verify (e.g. as described herein with reference to FIG. 14, step 1403) whether or not an end-user, presenting an offer identifier, is entitled to redeem same e.g. by determining whether or not advertiser-defined limits have been honored (e.g. no more than n redemptions per end-user for offer x or for any offer within group y. For example, “10 coins”, “100 coins”, “sword”, “helmet” are all different offers, but if they are defined within the system as a group, the group's limits may be applied on all of them) and/or, at least z time must have elapsed from the time of the last redemption on the part of a given end-user of this app's offer or group of offers.
Limitations may be global or per-offer or per group of offers. Typically, all limits must be honored; alternatively any logical combination of limits, typically as determined by the advertiser via the user interface of the present system, may be employed to determine eligibility of the end-user to the in-app content offered by the voucher. If and only if the validation process determines (verifies) eligibility of an individual end-user to an individual voucher, the advertiser activates the in-app content of the individual voucher, for the individual end-user.
“advertiser account”: a logical set of all system-stored data related to a certain advertiser within the system e.g. all of the advertiser's apps, security settings, login data, and other data.
   Virtual Voucher aka Voucher aka In-app content item Voucher: a virtual object, entitling an individual end-user to use of a particular Content Offer.
   Also: a virtual object which bestows an In-app content item, conditionally or unconditionally, on a user of an app.

Certain embodiments of the present invention seek to provide a mobile in-app content redemption system for app advertisers over the Internet which may be mediated by a tracker or an app activation link.

Certain embodiments of the present invention seek to provide a system and method allowing advertisers to provide virtual content inside their apps to acquired users and to record the interactions of the user with the provided virtual content.

Certain embodiments of the present invention seek to provide a system and method for tracker-mediated mobile in-app content redemption for application advertisers over the Internet, that allow a digital advertiser to offer virtual content unique to an application, over the Internet, such as character upgrades, free game levels, virtual objects or any other application-specific virtual items or virtual currency, to a user currently using some other application or website, such that once the user accepts the offer, only he, or, optionally, another user who has his permission, can subsequently redeem and then use the accepted offer as he accesses the advertiser's application.

Certain embodiments of the present invention seek to provide a system to use trackers to redeem in-app virtual items.

Certain embodiments of the present invention seek to provide a system to monitor redemptions so as to facilitate app promotion including how many redemptions have occurred for an app, a set of apps (account), a user, a time period.

Certain embodiments of the present invention seek to provide a method for one-time setup performed on an advertiser's server, which allows an advertiser to intercept an installation/app-open trigger from an advertiser's tracking provider.

Certain embodiments of the present invention seek to provide a voucher management system in which setup is performed, typically in a one-time process, on an advertiser's server, thereby to allow the advertiser's server to intercept an installation/app-open trigger from the advertiser's tracking provider and to redeem in-app vouchers for the user that owns that installation. Trackers are used to facilitate redemption of in-app virtual items. The system typically handles some or all of information extraction, user identification, voucher inventory validation and preprocessing, and the advertiser's server typically is only tasked with actually enabling the pieces of content that an end-user, whose entitlement to the voucher is validated by the system, is entitled to.

This may, according to certain embodiments, be implemented on the client-side, e.g. by using the tracker's SDK in conjunction with the system's API, or by using app activation links; no tracker need be involved.

Certain embodiments of the present invention seek to provide a technology which will support non-incentivized user acquisition, in which an offer is used to convey virtual content from a digital advertiser, such as: “If you click or tap on this link, you can claim (redeem) this offer entitling you to a stash of 200 golden-swords in game X”. Rates of user acquisition are enhanced in that more users click on the digital ad and/or users stay longer in the game and/or their frequency of use increases and/or users' LTV improves.

Certain embodiments of the present invention seek to provide an offer definition process, which defines an offer as in-app content, including time/quantity limits on a per-user-basis and/or per-offer-basis and/or offer group level.

Certain embodiments of the present invention seek to provide an offer redemption process, which may include preparation, and which may operate with tracker input alone and/or may enforce time and quantity limits on a per-user-basis and/or per-offer-basis and/or offer group level, e.g. as described herein with reference to FIGS. 2, 5, 6.

Certain embodiments of the present invention seek to provide a system which accepts an advertiser's definition of groups of vouchers and/or groups of content offers and then imposes constraints on the group, such as but not limited to minimum redemption interval (between any two redemptions by the same user) and voucher expiration (X days from accept time).

A constraint or “redemption limit” may include any logical condition on any aspect of redemption of voucher/s given to end-user/s pursuant to content offer/s such as but not limited to temporal (time) or quantitative aspects of redemption. Redemption limits may be defined for an individual content offer, for all or for a pre-configured subset of end-user recipients thereof; for an entire group of content offers, again for all or a pre-configured subset of end-user recipients thereof. A wide variety of limits may be defined, such as but not limited to time-based limits and quantitative limits Examples of time-based limits include but are not limited to: a preconfigured time-period, which must have elapsed since previous redemptions by an individual end-user (“min redeem interval”); a preconfigured time-period must have elapsed since previous redemptions by an individual end-user—relative to the last redemption that the individual user has performed of an offer that belongs to the same group as the offer that the user is currently attempting to redeem; less than a preconfigured time-period must have elapsed since an individual end-user accepted a content offer corresponding to a voucher (“voucher expiration”), e.g. end-user x clicked on (accepted) an ad yesterday and must then redeem same within X days; redemption must occur before (say) 1 Jan. 2015; redemption of a voucher must occur within a preconfigured time-period since the user accepted (e.g. clicked on an ad presenting) the content-offer corresponding to a voucher. Example of quantitative limits include but are not limited to: only a preconfigured maximum number of redemptions are allowed per user/device id (“max redemptions per user”) for an individual offer; only a preconfigured maximum number of redemptions are allowed per user/device id (“max redemptions per user”) for an entire preconfigured group of offers.

According to certain embodiments, an over-the-Internet content redemption system and method for Advertisers is provided which is operative to promote Apps by offering Virtual Content from within those Apps. Once the user accepts the presented Content Offer, e.g. by clicking/tapping on the offer image or on an adjacent button, an offer-specific App Tracking URL may be invoked, which registers the invocation details with the tracker, indicating that the user has accepted the offer. The user is then redirected to the App's download page. Alternatively, instead of an App Tracking URL, an App Activation Link may be invoked, which immediately opens the user's app if the app is already installed on the user's device. Once the App opens, the app automatically enables any previously accepted content for the end user.

According to certain embodiments an offer definition process is made to a population of end-users, offering in-app content having an Identifier (e.g. as described herein with reference to FIG. 4), including requesting an App Tracking URL from a Tracking Provider. The URLs may be passed to publishers for storage and incorporation into ads that are served to end users. According to certain embodiments any End User who accepts a Content Offer may cause the App Tracking URL to be invoked by clicking on the ad. For example, if an end-user is playing an electronic soccer game on his personal computer, s/he may suddenly see a popup with an ad and decide to click on the ad; responsively, the URL is invoked and the browser takes the end-user directly to the app's download page to download the app.

According to certain embodiments, a content offer is presented e.g. as an electronic ad, and the ensuing redemption process may include some or all of the following:
a. trigger (notification) responsive to which the advertiser provides the system with the offer id alone but typically not a full voucher.
b. validation occurs including creation of a voucher which is returned to the advertiser.
c. content is enabled, typically after (b).
d. the voucher is marked as “redeemed”, typically after or in parallel to (c.).

Typically, each voucher comprises a certificate or object, given to a particular end user, that entitles her or him to a given offer. Typically the system is operative not to generate vouchers when the user accepts them (at click time), but only later, when the user tries to redeem the vouchers (after app install), e.g. as described herein with reference to FIG. 5, showing the voucher generated only at the end of the preparation process. Typically, until the voucher has been generated, all the end-user has in his “possession”, is the content offer ID delivered e.g. by the tracker or via an activation link. A voucher object (in the sense of object-oriented programming) may include some or all of:
unique id in the system
voucher state: redeeming|redeemed
last state change time (=creation time for newly generated vouchers)
offer id: a reference to the offer from which this voucher was generated.

When the advertiser performs the preparation process, typically on his client/server, this effectively generates a voucher on behalf of a particular user that installed the app. The voucher, once “given” to an end-user who then “owns” that voucher, entitles her or him to receive a particular content offer.

According to certain embodiments, activation links are an alternative to tracking links in that redemption may be based on activation link data alone and may not resort to tracker data.

Presentation of an offer to end-users may be publisher-specific and typically includes displaying an electronic ad and/or awaiting and/or prompting for responsive user input, optionally allowing the user richer interaction with the ad such as video controls, and (depending on the user's responsive input), either invoking the link or closing the ad. Typically, the ad comprises a pop-up served by a publisher within an individual one of: a computer game, app, web site, and printed poster with QR code, to an end-user.

According to certain embodiments, the system of the present invention enables an advertiser to distribute vouchers via any of a population of publishers, rather than interfacing with only a single publisher. Advantages include some or all of: increased volume/ad space; not limited to an individual publisher's supported ad formats, ability to leverage any targeting/optimization capability of any publisher and ability to compare voucher traffic from different publishers, and make decisions on which publishers to use in future, based on their performance.

According to certain embodiments, the user interface supports definition of some offers as anonymous (having anonymity) and others as non-anonymous.

According to certain embodiments, multiple vouchers for a single app may be redeemed collectively even if the given offer ID cannot be redeemed.

According to certain embodiments, voucher expiration may be computed based on tracker data (e.g. click time) and/or the system may keep track of voucher expiration at click time by overriding (and thus slowing down) tracking URLs.

According to certain embodiments, the system is operative to accommodate high loads common in mobile advertising e.g. millions of redemptions per day.

The present invention thus typically includes at least the following embodiments:

### Embodiment 1

A computer-implemented offer redemption process including:

receiving notification, from each of a plurality of supported trackers, each having a different known configuration, thereby to enable each of the supported trackers to pass at least one field, specific to the known configuration, in which an ID of an offer of content is stored, wherein the offer is defined as a quantity of a currency, to an advertiser having an account, upon app installation;

responsively to receipt of the notification, validating at least one of the offer id and the advertiser account using the at least one field in which the offer's ID is stored; and

if validated, using a processor for redeeming the offer including:
generating a voucher, having a unique voucher ID, and storing the voucher on a computer storage medium,
passing the voucher ID, a user/device id, an app identifier, the currency and the quantity to the advertiser such that the advertiser can enable the quantity of the currency in an app identified by the app identifier, for the user/device, and
marking the generated voucher as “redeemed” thereby to prevent recurring redemption.

### Embodiment 2

A computer-implemented method facilitating generation by an advertiser's programmer, of computerized content offers to be made to a population of end-users, the method comprising:

providing a user interface enabling an advertiser's programmer:
i. to define a set of content offers, each offer in the set being stored in association with an offer ID and including a quantity being offered by an advertiser, having an account, to at least one individual end user, the quantity being expressed in terms of currency recognized by an individual app from among a multiplicity of apps;
ii. to select a tracking provider from among several supported tracking providers (“trackers”) presented to the programmer by the user interface, each having a different, known, configuration; and
iii. to present previously stored instructions for preparing for subsequent transport of the offer ID to the advertiser via the tracking provider selected from among the supported trackers;
   wherein a processor associated with the user interface employs tracker-specific logic, pre-stored for each of the several supported tracking providers, which takes into account each tracker's known configuration and provides the advertiser's programmer, for each selected tracker, with the following:
a. integration instructions to on how to incorporate an offer id associated with the content in a predetermined location; and
b. integration code e.g. snippet for incorporation by the programmer on an advertiser's app, wherein the code is operative, when run on a processor, to cause the advertiser, upon installation of each individual app, to be notified of the offer id which was the source for the installation of the individual app, to redeem the individual content offer and to enable the quantity inside the individual app's current installation corresponding to the offer id.

### Embodiment 3

A process according to any of the preceding embodiments which includes receiving, during set-up, from an advertiser's programmer via a user interface, a definition of at least one redemption limit including a minimum time interval that must separate any two redemptions by the same end-user for an individual content-offer (“minimum redemption interval”) and validating the redemption limit during redemption by verifying that the minimum redemption interval is satisfied.

### Embodiment 4

A process according to any of the preceding embodiments wherein the user interface enables an advertiser's programmer to optionally define at least one per-end-user redemption limit, to be enforced during redemption of the content offer.

### Embodiment 5

A process according to any of the preceding embodiments wherein a user's click time is used to generate vouchers.

### Embodiment 6

A process according to any of the preceding embodiments wherein the user interface enables an advertiser's programmer to optionally define at least one per-offer-group redemption limit (“constraint”), to be enforced during redemption of the content offer by imposing the redemption limit on all vouchers associated with content offers belonging to the offer-group.

### Embodiment 7

A process according to any of the preceding embodiments wherein a device/user identifier is used to generate vouchers.

### Embodiment 8

A method according to any of the preceding embodiments and also comprising receiving, from the tracker, at least one tracker-specific field that store/s device and/or user identifier for at least one offer,

and using the device/user identifier in order to perform at least one of:

validating per-user limits for at least one non-anonymous offer;

validating group-level limits for at least one non-anonymous offer; and

associating a user or device to the voucher.

### Embodiment 9

A method according to any of the preceding embodiments and wherein, if a tracker is capable of providing at least one tracker-specific field that store/s user click time, the method includes accepting the field, and using the user click time in order to validate offer expiration based on advertiser settings.

### Embodiment 10

A method according to any of the preceding embodiments and also comprising storing the device/user identifier for vouchers defined as non-anonymous and not for vouchers defined as anonymous.

### Embodiment 11

A method according to any of the preceding embodiments and also comprising enforcing at least one redemption limit which comprises a limit on time.

### Embodiment 12

A method according to any of the preceding embodiments wherein subsequently, for each app installation, each tracker, despite configuration differences between itself and other trackers, is also able to notify the advertiser about at least one of: user click times and device/user identifiers.

### Embodiment 13

A method according to any of the preceding embodiments and also comprising enforcing at least one redemption limit which comprises a limit on time.

### Embodiment 14

A process according to any of the preceding embodiments wherein the interval is defined once for an entire offer-group which includes a plurality of content offers and the minimum redemption interval is subsequently validated during redemption of all of the plurality of content offers.

### Embodiment 15

A process according to any of the preceding embodiments which includes receiving, during set-up, from an advertiser's programmer via a user interface, a definition of a voucher's expiration time and validating the voucher's expiration time during redemption.

### Embodiment 16

A process according to any of the preceding embodiments wherein the voucher is stored, during redemption, in association with at least one of: user click time, device/user identifier, user/device ID.

### Embodiment 17

A process according to any of the preceding embodiments which includes determining the number of redemptions which occurred over a given time period for a particular user/device, for an individual offer.

### Embodiment 18

A method according to any of the preceding embodiments wherein the notification is provided by a tracker and wherein the field comprises a tracker-specific field.

### Embodiment 19

A process according to any of the preceding embodiments wherein the validating includes verifying that at least one end-user did not exceed a predetermined logical combination of a per-offer redemption limit and a per-group redemption limit

### Embodiment 20

A method according to any of the preceding embodiments wherein the notification is provided by an activation link and wherein the field comprises an activation link parameter field.

### Embodiment 21

A method according to any of the preceding embodiments wherein the redeeming occurs without overriding original tracking links (URLs), thereby reducing click latency caused by an end-user waiting with an empty Internet browser, by routing each end-user, who has accepted the offer, directly to the original tracking link rather than routing the end-user to the original link indirectly, via another server.

### Embodiment 22

A method according to any of the preceding embodiments and also comprising storing, and reporting to an advertiser, an indication of all voucher ids whose vouchers were successfully redeemed.

### Embodiment 23

A method according to any of the preceding embodiments and also comprising enforcing at least one redemption limit which comprises a limit on quantity.

### Embodiment 24

A process according to any of the preceding embodiments which includes determining the number of redemptions which occurred over a given time period for a particular user/device, for a group of offers.

### Embodiment 25

A computer program product, comprising a non-transitory tangible computer readable medium having computer readable program code embodied therein, the computer readable program code adapted to be executed to implement an offer redemption process including:

receiving notification, from each of a plurality of supported trackers, each having a different known configuration, thereby to enable each of the supported trackers to pass at least one field, specific to the known configuration, in which an ID of an offer of content is stored, wherein the offer is defined as a quantity of a currency, to an advertiser having an account, upon app installation;

responsively to receipt of the notification, validating at least one of the offer id and the advertiser account using the at least one field in which the offer's ID is stored; and

if validated, using a processor for redeeming the offer including:
generating a voucher, having a unique voucher ID, and storing the voucher on a computer storage medium,
passing the voucher ID, a user/device id, an app identifier, the currency and the quantity to the advertiser such that the advertiser can enable the quantity of the currency in an app identified by the app identifier, for the user/device, and
marking the generated voucher as “redeemed” thereby to prevent recurring redemption.

### Embodiment 26

A method according to any of the preceding embodiments wherein the previously stored instructions prompt to request at least one App Tracking URL from the selected Tracking Provider thereby to enable the App Tracking URL to be passed, subsequently, to an advertiser-selected e-content publisher from among a population of e-content publishers, for future serving, as part of an ad, to the end users of the selected publisher, wherein the predetermined location is disposed in a known value field in the known configuration of the selected tracker,

wherein, for each subsequent app installation resulting from a “source” offer from among the set of content offers, the offer ID and ad click time are routed to the predetermined location in the known configuration.

### Embodiment 27

A method according to any of the preceding embodiments wherein the previously stored instructions prompt to configure an activation link for the app of the content offer thereby to enable the activation link to be redirected, subsequently, through the tracking URL, by an advertiser-selected e-content publisher, as part of an ad, to end users of the selected publisher,

wherein the predetermined location is disposed in an activation link in the known configuration of the selected tracker, and

wherein, for each app installation resulting from a “source” offer from among the set of content offers, the offer id is transported via the activation link.

### Embodiment 28

A method according to any of the preceding embodiments wherein, for each the subsequent app installation, each end user, by invoking the App Tracking URL, navigating to the app download page, and downloading (if missing) and opening the app, triggers a notification to the advertiser of the offer id which was the source offer from which the app installation resulted.

### Embodiment 29

A method according to any of the preceding embodiments and wherein, for each subsequent app installation, each end user, by invoking the App Tracking URL, is then redirected by the selected tracker to the activation link, and wherein opening the app then triggers a notification to the advertiser of the offer id of a content offer which was the source offer from which the app installation resulted.

### Embodiment 30

A process according to any of the preceding embodiments which validates expiration based on a preconfigured point in time.

### Embodiment 31

A process according to any of the preceding embodiments which validates expiration if a preconfigured time-period has elapsed since an end-user accepted a content offer corresponding to the voucher.

Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer usable or readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes or a general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application. Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with some or all of the embodiments of the present invention. Any or all functionalities of the invention shown and described herein, such as but not limited to steps of flowcharts, may be performed by at least one conventional personal computer processor, workstation or other programmable device or computer or electronic computing device or processor, either general-purpose or specifically constructed, used for processing; a computer display screen and/or printer and/or speaker for displaying; machine-readable memory such as optical disks, CDROMs, DVDs, BluRays, magnetic-optical discs or other discs; RAMs, ROMs, EPROMs, EEPROMs, magnetic or optical or other cards, for storing, and keyboard or mouse for accepting. The term “process” as used above is intended to include any type of computation or manipulation or transformation of data represented as physical, e.g. electronic, phenomena which may occur or reside e.g. within registers and/or memories of at least one computer or processor. The term processor includes a single processing unit or a plurality of distributed or remote such units.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of at least one computer/s or computing system/s, or processor/s or similar electronic computing device/s, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate information as described herein e.g. by providing one or more modules in the processor/s to perform functionalities described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

### BRIEF DESCRIPTION OF THE DRAWINGS

Certain embodiments of the present invention are illustrated in the following drawings:

FIGS. 1-7 illustrate systems for performing various components of a virtual content redemption process.

FIG. 8 illustrates a system having the combined function of all of the systems of FIGS. 1-7.

FIGS. 9, 10, 11A-11B, 12, 13, 14 are simplified flowchart illustrations of example methods of operation for the systems of FIGS. 1-5 respectively; each flowchart illustration in this case may include some or all of the steps illustrated, suitably ordered e.g., but not necessarily, as shown.

FIG. 15-19 are simplified flowchart illustrations of example methods useful in conjunction with certain embodiments of the present invention.

FIGS. 20, 21 are simplified flowchart illustrations of example methods of operation for the systems of FIGS. 6-7 respectively.

FIG. 22 is a simplified functional block diagram of a simplified functional block diagram of an ODS useful in conjunction with certain embodiments of the present invention.

FIG. 23 is a simplified flowchart illustration of a set-up method which may be used in conjunction with any of the systems and methods shown and described herein.

FIGS. 24-25 are simplified flowchart illustrations of example methods useful in conjunction with certain embodiments of the present invention.

FIG. 26 is a simplified flowchart illustration of a real-time operation method which may be used in conjunction with any of the systems and methods shown and described herein, typically after having been set up using the set-up method of FIG. 23.

FIGS. 27-35 include simplified pictorial illustrations of screenshots which may be generated for an example user interface which may include, together with conventional screen displays like log-in, some or all of the screen displays or web-pages of FIGS. 28-35, which may lead to one another as per any suitable logic e.g. as per any or all of the relationships shown in FIG. 27.

Methods and systems included in the scope of the present invention may include some (e.g. any suitable subset) or all of the functional blocks shown in the specifically illustrated implementations by way of example, in any suitable order e.g. as shown.

Computational components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Any method described herein is intended to include within the scope of the embodiments of the present invention also any software or computer program performing some or all of the method's steps, including a mobile application, platform or operating system e.g. as stored in a medium, as well as combining the computer program with a hardware device to perform some or all of the steps of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

A Content Offer as used herein refers to a data element in computer storage whose data structure may include some or all of the following elements:
1. Offer identity: a plurality of bits that uniquely identify an offer across the system which implements the method of FIG. 8, such as a number or a string.
2. Amount: an alphanumeric representation, such as “10”, “15.5”, “+7” indicating value, expressed in a currency recognized by (having meaning within) an app.
3. Currency: an alphanumeric (say) representation of a virtual unit such as but not limited to “coin”, “diamond”, “sword”, “level”, “XP”, which has an app-specific meaning in an app, analogous to the meaning of being the owner of a “dollar” in the United States or “yen” in Japan. e.g. in a content offer of “200 diamonds”, “200” is the amount and “diamonds” is the currency.
4. Offer expiration time: an optional value that specifies when the offer expires in various ways, such as but not limited to the number of days since the offer was accepted, or a specific date and time of day. If this value does not exist, this typically means the offer is one that never expires after having been accepted by a user.
5. Optional Content Tracking Links: App Tracking URLs specific to this Content Offer, including the Content Offer ID.
6. Offer attributes: a plurality of Advertiser-specific key-value pairs, each representing a different custom offer attribute. Each attribute may have a different industry-standard database-compliant type such as but not limited to integer, double-precision number, string, timestamp, etc.
7. Anonymous: whether any vouchers generated for this Content Offer remain unassociated to any End User (this is required as some Tracking Providers prohibit the use of End User Identifiers by an Advertiser or any service on the advertiser's behalf).
8. Group identifier e.g. name: optional (zero or more) names of the Offer Groups that this Content Offer belongs to. Groups may, for example, be identified by a numeric ID, by referencing a group predefined by the advertiser, or in any suitable manner In a “group definition process”, type: 1) the advertiser defines a group for an app via the UI by specifying an identifier e.g. name for the group, a reference of the app's app id, and optional group level limits such as max redemptions per user and min redemption interval. 2) The group is stored in a storage medium 3) a unique id is system-assigned to the group.

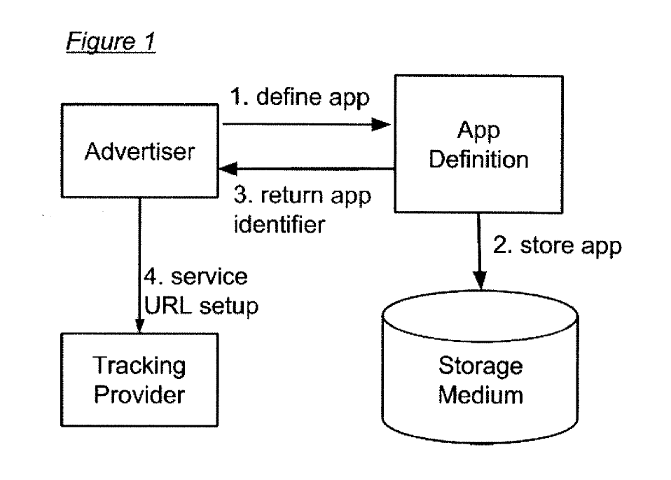

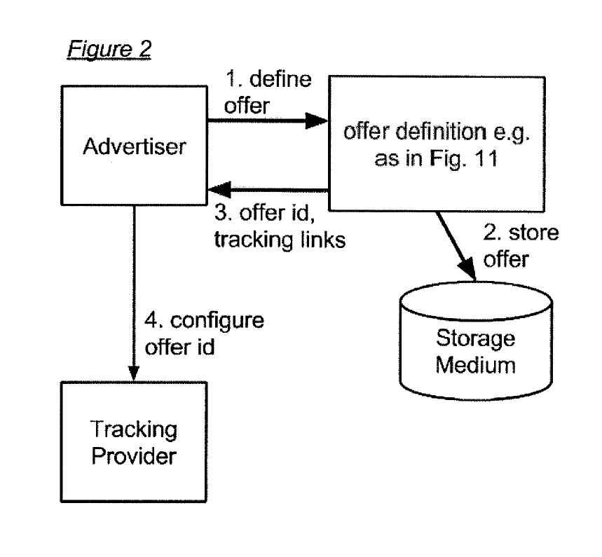

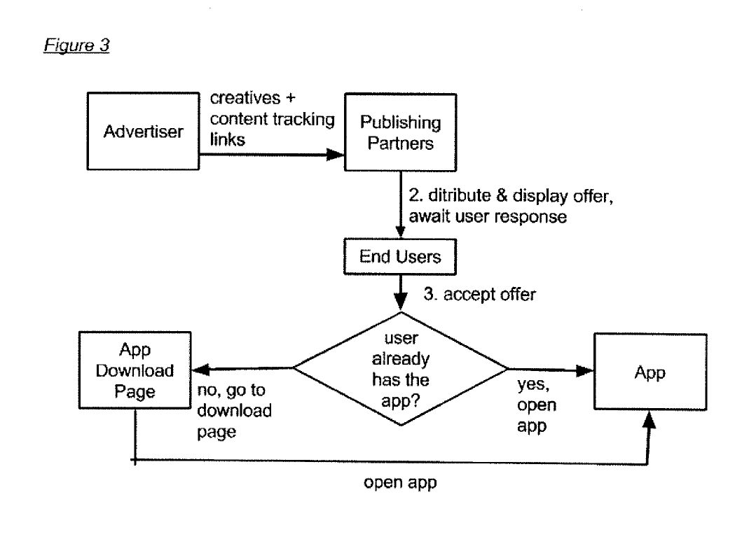

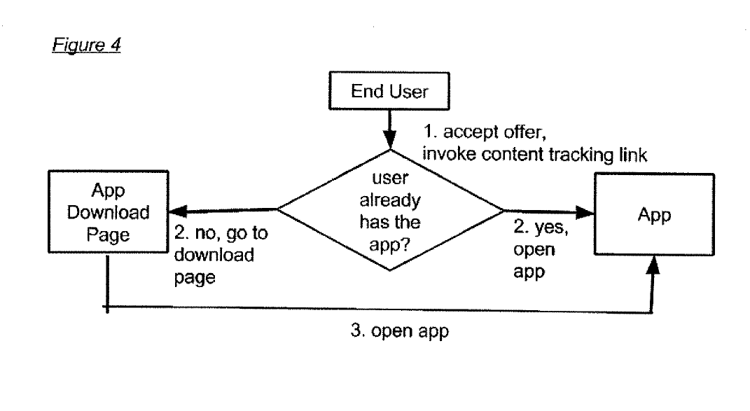

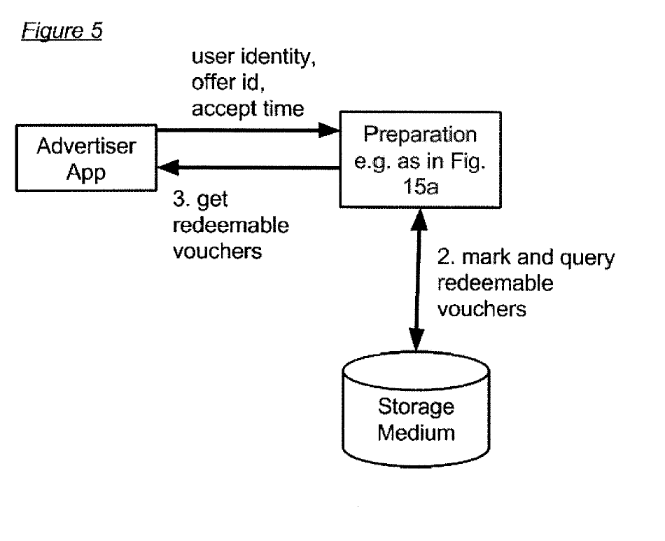

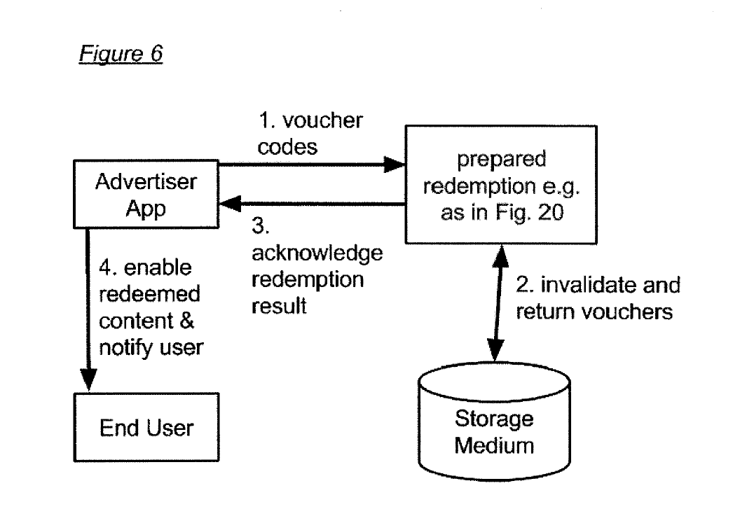

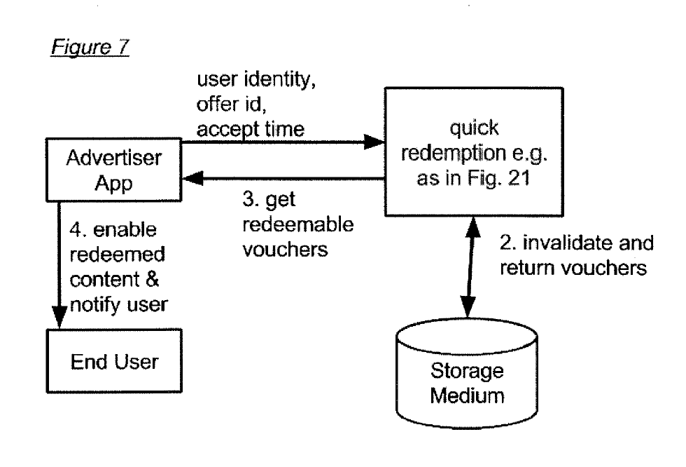

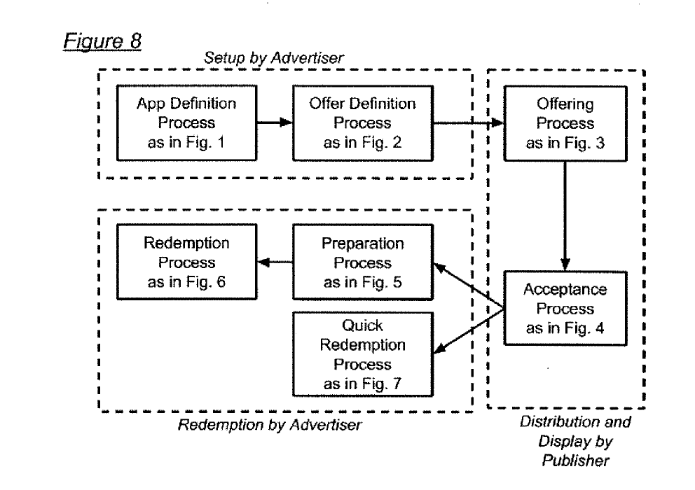

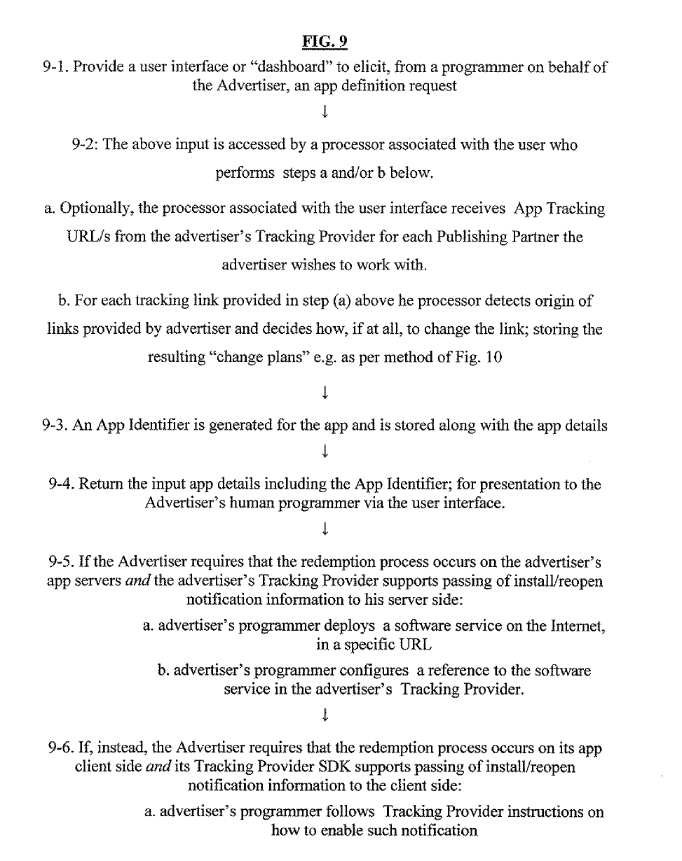

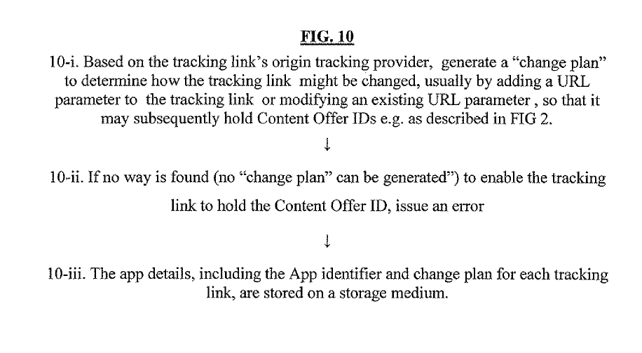

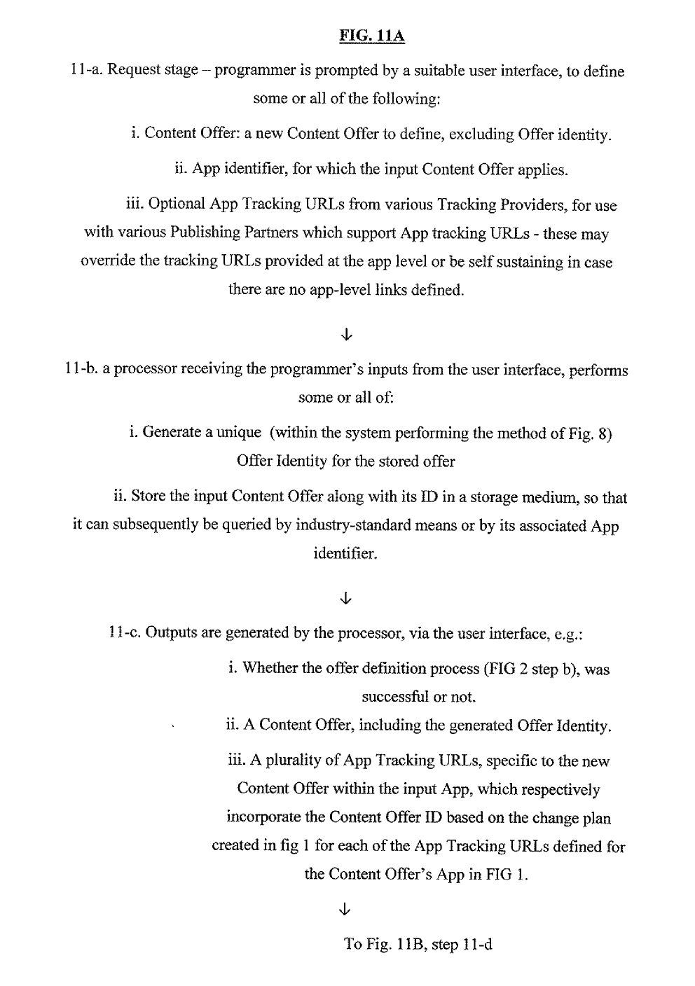

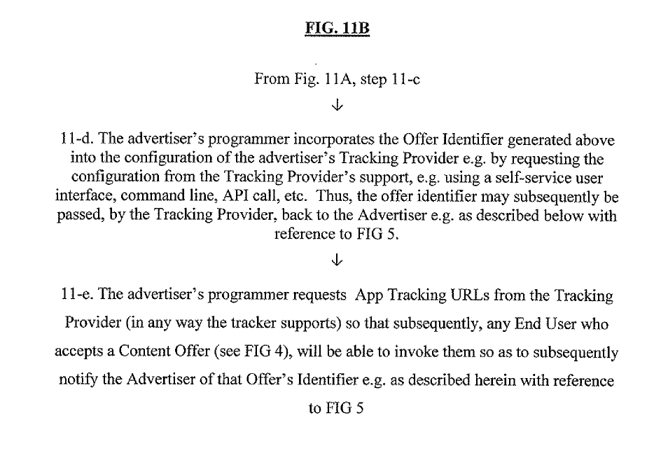

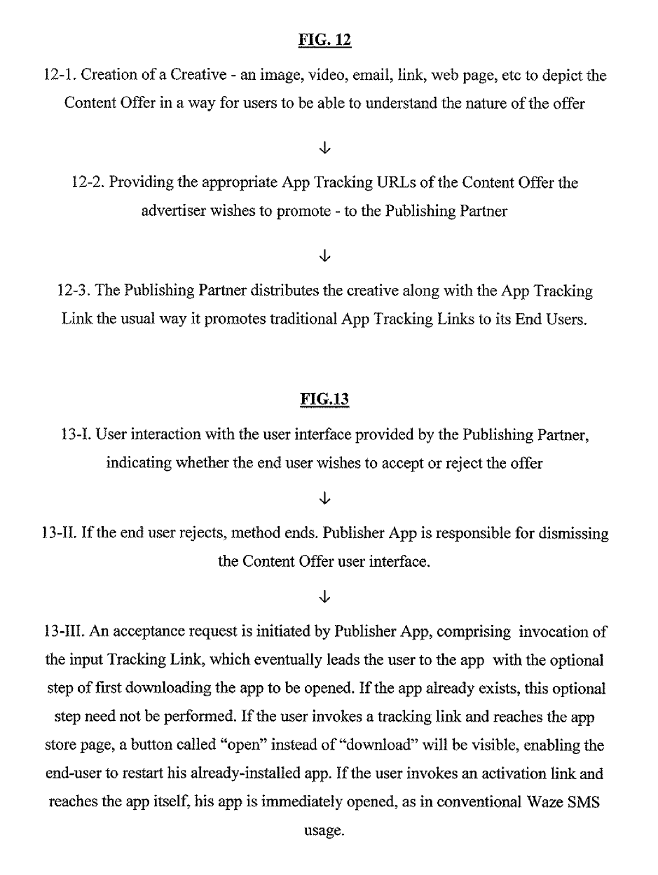

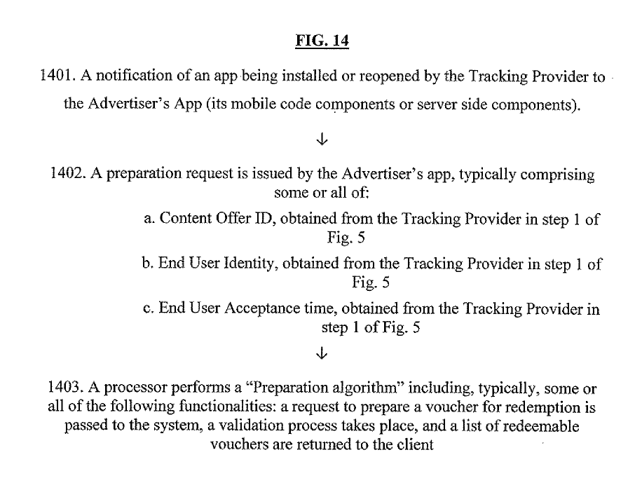

Reference is now made to the simplified functional block diagrams of FIGS. 1-7. Specifically, FIG. 1 is a simplified block diagram illustration of a system operative to perform an App Definition process, initiated by an Advertiser. FIG. 2 is a simplified block diagram illustration of a system operative to perform an Offer Definition process, initiated by an Advertiser or Publishing Partner. FIG. 3 is a simplified block diagram illustration of a system operative to perform an Offering process, initiated by an Advertiser, to present a Content Offer to end users. FIG. 4 is a simplified block diagram illustration of a system operative to perform an acceptance process, initiated by a user who responds to a Content Offer by accepting same. FIG. 5 is a simplified block diagram illustration of a system operative to perform a content Preparation process, initiated by an Advertiser App.

FIG. 6 is a simplified block diagram illustration of a system operative to perform a content redemption process, initiated by an Advertiser App after that advertiser app has obtained a list of redeemable Vouchers by the Preparation process. FIG. 7 is a simplified block diagram illustration of a system operative to perform a content quick-redemption process, initiated by an Advertiser App.

A simplified functional block diagram of a system for electronic advertising of content offers from setup to redemption, to a population of Internet end-users is illustrated in FIG. 8. As shown, the system of FIG. 8 typically employs some or all of the functionalities of FIGS. 1-7.

The system of FIG. 8 is typically operative for distributing and managing creation, modification and redemption of in-app (e.g. in-game) virtual content vouchers including some or all of create, modify, redeem, functionalities. FIG. 23 is a simplified flowchart illustration of a set-up method which may be used in conjunction with any of the above. FIG. 26 is a simplified flowchart illustration of a real-time operation method which may be used in conjunction with any of the systems and methods shown and described herein, typically after having been set up using the set-up method of FIG. 23.

Typically, each user of the system (each advertiser) may distribute in-app (e.g. in-game) content vouchers to end-users via the respective advertisers' existing publishers. Initial experiments conducted by the Applicant show that when 4000 users were exposed to conventional visual promotion, only four actually opened the promoted app, whereas when 4000 users were exposed to in-app content promotion as described herein, 80 end-users opened the app—20 times more.

Also, in a case study made by the Applicant over 400 installs, these indicated additional advantages: users who used the app after accepting a content offer had a session length increase of 250%, frequency of use increase of 30% and 1-day retention increase of 7%, compared to users who downloaded the same app in the same country, via traditional app promotions. Thus, the system shown and described herein provides a far more efficient technology for acquiring quality users for apps.

In the system of FIG. 8, vouchers are redeemable in exchange for app-specific content and the user typically need not explicitly present the voucher to anyone or anything since redemption occurs automatically due to the integration provided by the system of the present invention. In the system of FIG. 8, vouchers are typically non-uniquely (typically, multiple vouchers are associated with e.g. redeemed by a single user/device) identified by mobile device identifiers provided by trackers, when applicable, and/or custom advertiser user IDs like database row numbers or random hashed values. In contrast, a conventional voucher booking such as hotel vouchers, flight ticket vouchers, restaurant coupons may be based solely on user emails or Google/Facebook accounts, since these are the channels used to communicate the vouchers to the user.

Typically, the system of FIG. 8 provides voucher inventory controls including at least one of:

the ability to group voucher types together and impose constraints or limits on the group,

minimum redemption interval (a minimum time limit that must separate any two redemptions by the same end-user);

limit on maximum number of redemptions allowable for an individual user;

Typically, limits e.g. on minimum redemption interval, and maximum redeems per user are definable on both individual offer and group levels, in which case minimum redemption interval may be computed as the max between the offer and group levels, and max redeems per user may be computed as the min between the offer and group levels, and

voucher expiration (X days from accept time).

Typically, the system of FIG. 8 collects at least one of the following data elements:

how many redemptions occurred for a given app, a given set of apps (also termed an “account”), a given end-user, a given time period, and any suitable combinations of the above. According to certain embodiments, source code snippets are stored each of which perform the method of FIGS. 5 and 6 (typically other than the first step of FIG. 20), for a given language such as PHP, Java, C#, ObjC, Python, Ruby, JavaScript, C, C++, ActionScript.

Alternatively or in addition, source code snippets are stored, each of which perform the method of FIG. 7 (typically other than the last step of FIG. 21) for a given language such as the above. A user interface enables a human programmer representing the advertiser, in a set-up stage (FIG. 8) to input a language that s/he employs and, typically, to select either the quick-redemption option of FIG. 7 or the prepared redemption option of FIG. 6 which typically uses the preparation method of FIG. 5 as a prerequisite. Responsively, a suitable source code snippet is provided to the human programmer.

Typically, the set-up stage takes place each time an app (or group of apps) is defined or entered into the system of the present invention, e.g. using the subsystem of FIG. 1. Typically, e.g. as shown in FIG. 5, app information is returned by the system of the present invention to the advertiser along with voucher information, so the advertiser's programmer can use both app and voucher currency info to understand which content to enable in which app. For example, at FIG. 20, step 2001 (enablement of content) the advertiser's programmer might perform a first “switch statement” that checks which app the voucher is for, and then another switch statement to check the voucher currency to enable per-app. Pseudo code:

switch (app.name) {
case “My Dragons Game”:
switch (voucher.currency) {
case “sword”: ... enable sword...
case “armor”: ... enable armor...
}
case “My Puzzle Game”:
switch (voucher.currency) {
case “coins”: ... enable coins...
case “diamonds”: ... enable diamonds...
}
}

In the set-up stage, source code is generated (e.g. as per FIG. 1) to implement a suitable redemption process e.g. that of FIGS. 5 and 6, or that of FIG. 7. Subsequently, after a user downloads and opens an app, the redemption code is run.

Typically, the programmer accesses a suitable source code snippet as above, and adds additional source code to implement step 2001 in FIG. 20 and/or the last step of FIG. 21, if and as necessary. As described in step 9-4 of FIG. 9, the resulting source code snippet, implementing the methods of FIG. 5, 6 or the method of FIG. 7, may then be incorporated into the advertiser's server. The advertiser may deploy the source code of FIGS. 5-7 on his server only, or on his client-side (app).

The tracking provider is configured (e.g. as per FIG. 9, step 9-5) to include a link termed herein a “notification URL” which leads to or refers to the advertiser's server at which the source code resides. The tracking provider is then able to notify the advertiser's server, using the notification URL, of each app installation.

Typically, configuration is effected by the advertiser's programmer through a web UI or other interface provided by the tracker, as part of the setup process e.g. as described herein with reference to FIG. 1. Typically, the notification URL is only applicable when the advertiser's programmer decides on implementing a server-side redemption (e.g. as described in FIG. 1). If the advertiser's programmer decides on implementing a client-side redemption, then there is no need to set a notification URL.

In addition to installs, reopen events are also supported e.g. as described hereinbelow in detail.

It is appreciated that the system of the present invention may include an acceptance API (e.g. to perform the functionalities described herein with reference to FIG. 4) and/or an offering API or alternatively, the offering process e.g. as described herein with reference to FIG. 3 may be handled by a conventional publishing partner. Any suitable integration with the tracking providers may be provided e.g. as described herein. A particular advantage of the integration described herein is that the solution is thereby rendered “SDK-less”; no changes to the existing app are required. Alternatively, an SDK may be embedded into the app and suitable code changes may be made thereto. However, SDK-enabled solutions are also within the scope of embodiments of the present invention and may be more practical e.g. if the app is such that an SDK-enabled solution simplifies integration.

According to certain embodiments, a processor associated with the user interface employs tracker-specific logic, pre-stored for each of the several supported tracking providers, which takes into account each tracker's known configuration (e.g. how the tracker performs notification, which tracker-specific field stores the offer id, and how the tracker generates tracking links), and provides the advertiser's programmer, for each selected tracker, with integration instructions on how to incorporate the offer id in a predetermined location in the configuration of the selected tracker, such that subsequently, for each app installation, each tracker is able, by invoking the App Tracking URL responsive to end-user acceptance of the content offer, to notify the advertiser which offer id was the source for the installation, responsive to which the end-user's browser, is able, during redemption, to take the end user to the download page of the app identified by the identifier, thereby allowing the end-user to download the app.

It is appreciate that activation links may be employed to bypass the trackers altogether, but still cause the user to reopen an app. In this case, the solution is often a client-side solution rather than a server-side solution e.g. if the service-side infrastructure of allowing notification URL invocation is provided by trackers, since if an activation link bypasses the tracker and simply opens the app, tracker mechanics cannot be utilized and may be replaced by client-side code typically operative to: trigger once the app is reopened, take the offer id off the activation link, extract the user/device id from within the app itself, and perform the code of FIGS. 5-7. It is appreciated that advertisers may prefer client-side implementation e.g. if their tracker handles notification of installs but not of reopens but the advertiser wishes to target existing users as opposed to or in addition to new ones.

Invoking activation links may optionally inform the advertiser of an installation (say) of his app by providing the Identifier (offer ID) to the advertiser directly without tracking involvement, e.g. for tracking URLs that the advertiser creates for himself (as in Waze).

Still with reference to FIG. 8, one or more App Tracking URLs are typically requested from the Tracking Provider selected by the advertiser's programmer via the user interface, because each publisher gets one URL, and the advertiser usually works with many publishers at once. Also, sometimes a link (e.g. a “activation link”) is not from a tracking provider, and is instead generated by the advertiser himself.

Typically, in a set-up stage, a set of at least one app/s is defined e.g. by performing some or all of the following steps, suitably ordered e.g. as shown:
a. selecting, via the user interface, a source code snippet performing at least a portion of a voucher redemption process; and
b. incorporating at least the source code snippet into an advertiser's server or client; and (if the advertiser chose server-side code implementation),
c. configuring the tracking provider to include a “notification URL”,
which routes to the advertiser's server at which the source code resides, thereby to allow the tracking provider to notify the advertiser's server, using the notification URL, of (at least) each subsequent installation of the at least one app. Typically, there are also notifications about re-engagements of the app—not just installation thereof. For example, a user who already has the app and has stopped using the app, is exposed to an offer through some ad, and clicks on the ad. The tracking URL redirects him to the app itself (or to some page that allows the end-user to open the app by another click), and the app reopens, at which point the tracker notifies the advertiser that “re-engagement” has occurred. At this point, the advertiser is able to complete the redemption, as for an install event. It is appreciated that some trackers support the above functionality only on the client side or only on the server side, but not both. Also, some trackers support the above functionality for only some publishers, but not all.

According to some embodiments, the “offer id” may be embedded on the tracking link instead of in the tracker configuration. This may require an intermediate server to replace the original server that was in the original link. The “intermediate server” may redirect the user to the original tracking link (and server) after manipulating the link to incorporate the offer id thereinto. This causes latency for the user, who goes through two servers instead of just one, to get to his app.

It is appreciated that conventionally, publishers distribute tracking links to end user, such that, when an ad is clicked, the device invokes the tracking link, which in turn opens an app-either the app being promoted or an app store page, from which the user downloads the promoted app. The system of the present invention typically eliminates integration impact with publisher networks.

The system of the present invention makes no changes to tracking links other than changes that are compatible with publishers including avoiding breaking the link contract of existing integrations between publishers and tracking providers. The result is transparency: the publisher networks use the tracking link provided by the system of the present invention exactly as they would use the original tracking link obtained from the advertiser. Thus, any information the publisher network wishes to pass to an advertiser's tracking provider remains intact, and each advertiser maintains all of its original tracking capabilities with its tracking provider.

Instead of advertisers giving their tracking link directly to their respective publisher networks, the tracking links are provided by the advertisers to the system of the present invention, which responsively gives the advertiser an alternative tracking link to hand over to the advertiser's publisher network. The alternative tracking link that the system gives the advertiser may or may not include changes in order to enable voucher redemption, depending on the features of the particular tracker being used by the advertiser e.g. how the underlying tracker infrastructure works. For some trackers, changing the link by the system may not be necessary, and the same link, typically with some tracker-side configuration (e.g. as described herein with reference to FIG. 2), is given back to the advertiser. The system of the present invention stores relevant features for each of a supported plurality of trackers (tracking infrastructures), which allow the system to support advertisers using each individual tracker in the supported plurality of trackers.

Typically, “change plans” are a stored indication of changes to be made to an input tracking link, typically including one or more new link parameters to be added to include the offer ID or existing link parameters to be populated with the offer ID. The data may be stored in computer memory as “tracking link” objects e.g. in a suitable database table, and typically comprises some or all of: the original link as added by the advertiser, the associated app, the parameters to add, the existing parameters to use, the alternative link which points to the alternative server, the original protocol and host name in a separate field, the tracker name and the publisher name. “Change plans” are typically tracker-specific and are used in embodiments in which optional tracking links are employed e.g. as described herein with reference to FIG. 10. Instructions on how to embed the offer id into the tracker configuration need not be related to tracking links, and many for example be related to a location (e.g. in a tracking link or some other suitable portion of the configuration) where the offer id may be set.
Example: Given is an original link for AppsFlyer tracker, for the NativeX publisher, to which an offer ID is to be added; the app definition process shown and described herein may make the decision on how to add the offer ID based on the app definition's stored knowledge of AppsFlyer tracking link formats. The app definition process shown and described herein may also make the decision on how to build an object to represent the tracking link along with data to be used at runtime to redirect from one server to the original server. In this example:
Original link: http://app.appsflyer.com/click/?c=myapp&pid=nativex_int&idfa=#IDFA#
the resulting object containing the following fields:
id: unique id in the system database
app id: the app that this link belongs to
original link: as above
external link:
http://api.trophit.com/click/?c=myapp&pid=nativex_int&idfa=#IDFA#&trophit ref={tr ophit.ref}
same as the original link, different server, with an extra parameter placeholder {trophit.ref} that may later be replaced at offer definition time with an actual offer id+this link's id, e.g. “123_{—}456” would indicate offer id 123 and link id 456. At click time, this information may help the intermediate server extract offer and link information in order to perform redirection properly.

parameters to add: of sub5={trophit.code}
The system shown and described herein knows as per pre-stored knowledge as described herein, that af_subXX parameters are AppsFlyer-specific parameters that can be used to convey custom data on the link. The system may decide to use af_sub5 if available, or af_sub4 if not, af_sub3, and so on. The system then typically populates the chosen parameter with a placeholder {trophit.code} that may be replaced at offer definition time with the actual offer id and link id.
parameters to use: none—since the original link does not already contain the offer id placeholder, there are no existing parameters that can be used, so this field remains empty
original server: http://app.appsflyer.com
used at click time to redirect the incoming link to the original server, along with all incoming parameters
name of the publisher: nativex_int
used later on to show the link list to the user, so he may easily see which link belongs to which publisher
name of the tracker: AppsFlyer
detected based on the original server name xxx.appsflyer.xxx

It is appreciated that adding support for another tracker may be based on similar, already supported trackers, e.g. if a new tracker has a list of parameters that are available to hold the offer IDs which are not being used by publishers for some other purposes, and assuming that a procedure is available to detect the tracker by the tracker's links, using the server name. Optionally, path components such as /a/b/c may be used to contain offer IDs rather than using query parameters like &a=x&b=y. Typically, once a “detector” component utilized by app definition is able to determine the tracker of a link, the component may delegate the link processing to a tracker-specific “link maker” object that holds the tracker-specific logic to create the tracking link object as described above, potentially adding more fields to the existing fields described above to hold data useful for building offer-specific links at offer definition time, and performing redirection at click time.

The apparatus of FIG. 8 is operative in conjunction with a suitable user interface which prompts the advertiser's programmer to provide inputs e.g. as defined herein for app and offer processing (e.g. amount and currency, anonymity, etc. for an offer). The UI also typically supports generation by the advertiser's programmer of ready-to-deploy code snippets as described herein. Also, some or all of a login page, sign up page, “forgot password” page, app list page for editing apps previously added, offer list page for editing existing offers, and account settings may be provided.

FIGS. 1-7, as well as methods of operation thereof illustrated in FIG. 9 onward, are now described in more detail.

FIG. 1 describes an apparatus for performing a “set-up” app definition process, where an advertiser sets up an app for which he wishes to promote content offers using the method of FIG. 8.

The computer storage medium in FIG. 1 (as well as FIGS. 2, 5, 6, etc.) may store some or all of the following data elements e.g. in suitable fields in suitable data tables:
tracker: predefined list of supported trackers: id, name
account: id, name, status (enabled/disabled)
app: id, name, external id, owning account id, used tracker id
   offer: id, currency, amount, owning app id, anonymous (yes/no), max redeems per user, min redeem interval, description, group id, expiration (e.g. in n days), expiration point in time
group: id, owning app id, name, max redeems per user, min redeem interval
device: apple advertiser id, google advertiser id, google android id
voucher: id, offer id, app id, device id

FIG. 9 is an example method of operation for the apparatus of FIG. 1, which may comprise some or all of the following steps, suitably ordered e.g. as shown:

After step 3, the method of FIG. 9 branches out, depending on whether redemption is desired to occur on the server side (STEP 9-4) or on the client side (STEP 9-5), in which case a suitable SDK may be employed as described below.

Regarding part b of step 9-b in FIG. 9, it is appreciated that configuration varies between tracking providers. Examples are as follows:

i. MobileAppTracking: use their self-service dashboard to add a “Postback URL”, which includes the service URL as well as URL parameters such as campaign name, device identifiers, click time
ii. AppsFlyer: use their self-service dashboard to add a “custom Installation Push API”, which includes the service URL
iii. Adjust: use their self-service dashboard to add a “callback URL”, which includes the service URL as well as URL parameters such as tracker name, device identifiers, click time
iv. AD-X: email their support and request an all-traffic postback, which includes the service URL as well as URL parameters like campaign name, device identifiers, click time
v. Google Play bulit-in tracking: add an extra component to the referrer URL parameter, e.g. &referrer=a_b_c<offer id comes here>

The Preparation, Prepared Redemption and Quick Redemption process may be implemented inside its service, e.g. as described in FIG. 5, 6, 7, e.g. as follows:

i. If the app is suitable for the Quick Redemption method of FIG. 7, the Preparation and Redemption method of FIGS. 5-6 need not be implemented, and vice versa
ii. If the same service receives notifications for more than one app, the Advertiser may decide to implement a different redemption method for each app, for example one app may use the Preparation and Redemption of FIGS. 5-6, while another app may use Quick Redemption as per FIG. 7.

It is appreciated that alternatively, implementation may be client-side e.g. as described herein.

The method of FIG. 9 may include some or all of the following steps 9-1, 9-2, . . . , suitably ordered e.g. as follows:

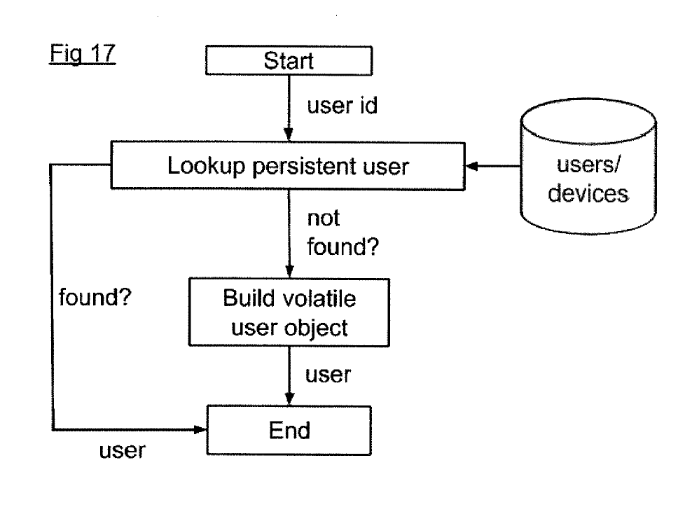

9-1. Provide a user interface or “dashboard” to elicit, from a programmer on behalf of the Advertiser, an app definition request, comprising:
i. App name
ii. Tracking Provider: the name of the Tracking Provider (one or more, although in some implementations, it is limited to one only) that the Advertiser uses for this app
iii. Optional App Tracking URLs from App's Tracking Providers, for use with various Publishing Partners which support App tracking URLs. In some implementations, when the Tracking Providers have the means to generate such links by their own means, this input is not required from the Advertiser.
9-2: The above input is accessed by a processor associated with the user who performs steps a and/or b below.
a. Optionally, the processor associated with the user interface receives App Tracking URL/s from the advertiser's Tracking Provider for each Publishing Partner the advertiser wishes to work with. If the tracker is capable of generating these links independently, the links need not be provided by the processor.
b. For each tracking link provided in step (a) above the processor detects the origin of the links provided by the advertiser and decides how, if at all, to change the link; storing the resulting “change plans” as part of the link information stored by the system of the present invention e.g. as per the method of FIG. 10.
9-3. An App Identifier is generated for the app and is stored along with the app details. The app identifier typically comprises a plurality of bits that uniquely identify the App across the system implementing the method of FIG. 8. The app id is useful for identifying its app, since the app may have multiple offers each with its own unique offer id.
9-4. Return the input app details including the App Identifier; for presentation to the Advertiser's human programmer via the user interface.
9-5. If the Advertiser requires that the redemption process occurs on the advertiser's app servers and the advertiser's Tracking Provider supports passing of install/reopen notification information to his server side:
a. advertiser's programmer deploys a software service on the Internet, in a specific URL
b. advertiser's programmer configures a reference to the software service in the advertiser's Tracking Provider.
   9-6. If, instead, the Advertiser requires that the redemption process occurs on its app client side and its Tracking Provider SDK supports passing of install/reopen notification information to the client side:
a. advertiser's programmer follows the Tracking Provider instructions on how to enable such notification, e.g. as follows:
   i. Adjust.io on iOS: implement a delegate method which is called by the Adjust.io SDK with notification information, and from there, implement as in FIG. 5-6 or 7 (and corresponding flows of FIGS. 14-20 and 21, 24-25).
   ii. AppsFlyer on iOS: implement a delegate method which is called by the AppsFlyer SDK with notification information, and from there, implement as in FIG. 5-6 or 7 (and corresponding flows of FIGS. 14-20 and 21, 24-25).

The method of FIG. 10 may include some or all of the following steps 10-i, 10-ii, . . . , suitably ordered e.g. as follows:

10-i. Based on the tracking link's origin tracking provider, generate a “change plan” to determine how the tracking link might be changed, usually by adding a URL parameter to the tracking link or modifying an existing URL parameter, so that it may subsequently hold Content Offer IDs e.g. as described in FIG. 2.

An example of “change plans” follows:

1. A MobileAppTracking link that looks like “original” below” may be changed by adding an extra URL parameter called aff_sub5=<content offer id, say, 345>, e.g. as follows:
original: http://api03.hastrk.com/?offer_id=1234&af_sub1=axnet&pubid=6653
changed: http://api03.hastrk.com/?offer_id=1234&af_sub1=axnet&pubid=6653&aff_sub5=345 In this example, then, the change plan is to “add” an extra URL parameter “aff_sub5” with the value “345”.
2. An AppsFlyer link that looks like “original” below may be changed by modifying an existing URL parameter called install_callback, substituting a {content_offer_id} placeholder with an actual offer id, say, 345; e.g. as follows:
original:
http://app.appsflyer.com/?offer_id=1234&af_sub1=axnet&pubid=6653&c={content offer id}
changed: http://api03.hastrk.com/?offer_id=1234&af_sub1=axnet&pubid=6653&c=345
In this example, then, the change plan is to “change” an existing URL parameter “c” from “{content_offer_id}” to “345”.
10-ii. If no way is found (no “change plan” can be generated”) to enable the tracking link to hold the Content Offer ID, issue an error
10-iii. The app details, including the App identifier and change plan for each tracking link, are stored on a storage medium.

The content offer is typically associated in computer memory with at least one advertisement by an “offer ID”. A single app may have multiple ads, each having different targeting parameters (e.g. each targeting a different audience such as Russian ads vs. English ads). Similarly, a content offer may have multiple ads, each targeting a different audience. A “content offer” typically has a one-to-many relationship with ads.

Typically, each voucher is recognized by the app associated therewith because of the source code generated e.g. as described herein with reference to FIGS. 5,6 and their associated flows e.g. as per FIGS. 14-20, 24-25. Typically, when the offer id is passed to the system for redemption, a voucher is generated by the system and returned to the advertiser. At that point, the advertiser reads the voucher “currency” and “quantity” and maps that to app-specific code that enables that piece of content to the current end user.

FIG. 2 describes an apparatus for performing the Offer Definition process, where an Advertiser defines a Content Offer. FIGS. 11A-11B, taken together illustrates a suitable method of operation for the apparatus of FIG. 2, comprising some or all of the following steps, suitably ordered e.g. as shown.

It is appreciated that implementation of step d is specific to each of the various Tracking Providers. For example, some or all of the following implementations may be used for various well-known Tracking Providers:

i. MobileAppTracking: use their self-service dashboard to create a new campaign, whose name contains the Offer Identifier, e.g. “200 coins (<offer id>)

ii. AppsFlyer: use their self-service dashboard to set the Offer Identifier as the campaign name when generating a Tracking URL for any media source (Publisher).

iii. Adjust: use their self-service dashboard to add a tracker, whose name contains the Offer Identifier, e.g. “MyPublisher—200 coins (<offer id>)

iv. Chartboost: use their self-service dashboard to create a new campaign, whose name contains the Offer Identifier, e.g. “200 coins (<offer id>)

v. Any Tracking Provider, when publishing the Content Offer on Facebook: also requires that the Offer Identifier be defined inside a Facebook ad campaign, in the campaign name, ad set name or ad name.

The method of FIGS. 11A-11B, taken together may include some or all of the following steps 11-a, 11-b, . . . , suitably ordered e.g. as follows:

11-a. Request stage—programmer is prompted by a suitable user interface, to define some or all of the following:

i. Content Offer: a new Content Offer to define, excluding Offer identity.

ii. App identifier, for which the input Content Offer applies.

iii. Optional App Tracking URLs from various Tracking Providers, for use with various Publishing Partners which support App tracking URLs—these may override the tracking URLs provided at the app level or be self sustaining in case there are no app-level links defined.

11-b. a processor receiving the programmer's inputs from the user interface, performs some or all of:

i. Generate a unique (within the system performing the method of FIG. 8) Offer Identity for the stored offer

ii. Store the input Content Offer along with its ID in a storage medium, so that it can subsequently be queried by industry-standard means such as, but not limited to, SQL queries, key cache queries, by its Offer Identity or by its associated App identifier.

11-c. Outputs are generated by the processor, via the user interface, typically including some or all of the following:
i. Whether the offer definition process (FIG. 2 step b), was successful or not.
It is appreciated that this process may fail e.g. due to missing input or network errors or validation of links e g as described herein
ii. A Content Offer, including the generated Offer Identity.
iii. A plurality of App Tracking URLs, specific to the new Content Offer within the input App, which respectively incorporate the Content Offer ID based on the change plan created in FIG. 1 for each of the App Tracking URLs defined for the Content Offer's App in FIG. 1. Typically, the change plan comprises natural language instructions for the programmer using the GUI and the programmer receives ready-to-use links that incorporate the changes.
   11-d. The advertiser's programmer incorporates the Offer Identifier generated above into the configuration of the advertiser's Tracking Provider e.g. by requesting the configuration from the Tracking Provider's support, e.g. using a self-service user interface, command line, API call, etc. Thus, the offer identifier may subsequently be passed, by the Tracking Provider, back to the Advertiser e.g. as described below with reference to FIG. 5.
   11-e. The advertiser's programmer requests App Tracking URLs from the Tracking Provider (in any way the tracker supports) so that subsequently, any End User who accepts a Content Offer (see FIG. 4), will be able to invoke them so as to subsequently notify the Advertiser of that Offer's Identifier e.g. as described herein with reference to FIG. 5. If the tracking provider supports the creation of such links, the Tracking URLs provided in step 9-1 of FIG. 9 may not be required and the Advertiser may not need to define them.

With reference to FIGS. 1, 9-10 and 11A-11B: a content offer (typ including App Tracking URL and a creative such as an image, web page, video, etc.) is typically served by a publisher to its end-users, and offers to give an individual end-user of the publisher a voucher which upon subsequent presentation to an app entitles the publisher's end-user to in-app content as defined in the voucher, unconditionally or conditionally

Typically, the embodiment of FIG. 1 is not limited to install/open events only, but may also support other events such as deposit and certain achievements within the app as well. If the offer is entirely unconditional, all the end-user may needs to do is to accept the content offer e.g. by clicking or tapping. According to certain embodiments, as described herein, once the user opens the app, and the tracker decides to notify the advertiser that this is indeed an action that is associated to a click on some voucher ad, the code in FIG. 5 is invoked and the user gets the voucher unconditionally. However, alternatively, the user interface may support accepting from an advertiser a simple or complex logical condition for the redemption, e.g. telling the user (on the ad visual itself) and subsequently enforcing that the end-user needs to download the app as well as (say) reach level 3 in the app or some other condition for getting the voucher. In such cases, the tracker will notify the advertiser server (via the notification URL) that a (say) “level 3 event” has occurred, and the system will effect the redemption at a suitable time.

Still with reference to FIGS. 1, 9-10 and 11A-11B, a content offer (typ including App Tracking URL and a creative such as an image, web page, video, etc.) is typically served by a publisher to its end-users, and offers to give an individual end-user of the publisher a voucher which upon subsequent presentation to an app entitles the publisher's end-user to in-app content as defined in the voucher, unconditionally or conditionally

Typically, the embodiment of FIG. 1 is not limited to install/open events only, but may also support other events such as deposit and certain achievements within the app as well. If the offer is entirely unconditional, all the end-user may need to do is to accept the content offer e.g. by clicking or tapping. According to certain embodiments, as described herein, once the user opens the app, and the tracker decides to notify the advertiser that this is indeed an action that is associated to a click on some voucher ad, the code in FIG. 5 is invoked and the user gets the voucher unconditionally. However, alternatively, the user interface may support accepting from an advertiser a simple or complex logical condition for the redemption, e.g. telling the user (on the ad visual itself) and subsequently enforcing that the end-user needs to download the app as well as (say) reach level 3 in the app or some other condition for getting the voucher. In such cases, the tracker will notify the advertiser server (via the notification URL) that a (say) “level 3 event” has occurred, and the system will effect the redemption at a suitable time.

FIG. 3 illustrates an apparatus operative for performing a conventional Offering process, where an Advertiser app offers a Content Offer, previously defined by the Offer Definition process, to an End User. A suitable method of operation for the apparatus of FIG. 3 is shown in FIG. 12. The method of FIG. 12 may include some or all of the following steps 12-1, 12-2, . . . , suitably ordered e.g. as follows:

12-1. Creation of a Creative—an image, video, email, link, web page, etc to depict the Content Offer in a way for users to be able to understand the nature of the offer
12-2. Providing the appropriate App Tracking URLs of the Content Offer the advertiser wishes to promote—to the Publishing Partner
12-3. The Publishing Partner distributes the creative along with the App Tracking Link the usual way it promotes traditional App Tracking Links to its End Users.
It is appreciated that activation links may replace app tracking links, or, since tracking links may redirect to other links, a tracking link may eventually redirect to an activation link. using conventional methods.

The method of FIG. 12 is conventionally performed by Publishing Partners active in distribution of creatives and URLs.

FIG. 4 illustrates an apparatus for performing an offer Acceptance process, e.g. as shown in FIG. 13. In the method of FIG. 13, an end user accepts an offer presented to him by a Publisher App, and eventually navigates to the App which is associated with the Content Offer the user accepts. The method of FIG. 13 may include some or all of the illustrated steps 13-I, 13-II, . . . , suitably ordered e.g. as follows:

13-I. User interaction with the user interface provided by the Publishing Partner, indicating whether the end user wishes to accept or reject the offer.
13-II. If the end user rejects, method ends. Publisher App is responsible for dismissing the Content Offer user interface.
13-III. An acceptance request is initiated by Publisher App, comprising invocation of the input Tracking Link, which eventually leads the user to the app with the optional step of first downloading the app to be opened. If the app already exists, this optional step need not be performed. If the user invokes a tracking link and reaches the app store page, a button called “open” instead of “download” will be visible, enabling the end-user to restart his already-installed app. If the user invokes an activation link and reaches the app itself, his app is immediately opened, as in conventional Waze SMS usage.

FIGS. 5-7, described below in detail, illustrate example methods for redemption of in-app content item vouchers through a voucher management system/platform for app developers which is able to manage voucher inventory and/or provide redemption control for multiple advertisers simultaneously.

Typically, the system can serve multiple advertisers because each advertiser who signs up to the system receives an account-specific set of credentials which allow the advertiser's programmer to manage advertiser's content offers and perform voucher redemptions only for offers owned by the advertiser. Typically, no one else can perform these actions on the advertiser's content unless the advertiser shares his credentials with someone else.

Typically, the system is operative for supporting multiple publishers for each advertiser because the app's (i.e. advertiser's) server receives a notification event from the tracking provider about a new install/reopen regardless of which publisher generated the click in the first place, as opposed to system servers traditionally receiving the notification from the tracker as if they were publisher servers, before passing it to the advertiser's server, in which case only traffic that the system itself generated as a publisher, would be received.

FIG. 5 illustrates an apparatus for performing a redemption Preparation process performed when a set of one or more new apps is installed, to ensure that data flows appropriately from tracker to advertiser to the system shown and described herein. Typically, an Advertiser App prepares any applicable vouchers for redemption, initiated whenever an End User opens the App for the first or non-first time, or after some App-specific action that the user performs. A suitable method of operation for the apparatus of FIG. 5 is illustrated in FIG. 14. The process of FIG. 14 may include some or all of the following steps 1401, 1402, . . . , suitably ordered e.g. as shown.

1401. A notification of an app being installed or reopened by the Tracking Provider to the Advertiser's App (its mobile code components or server side components).

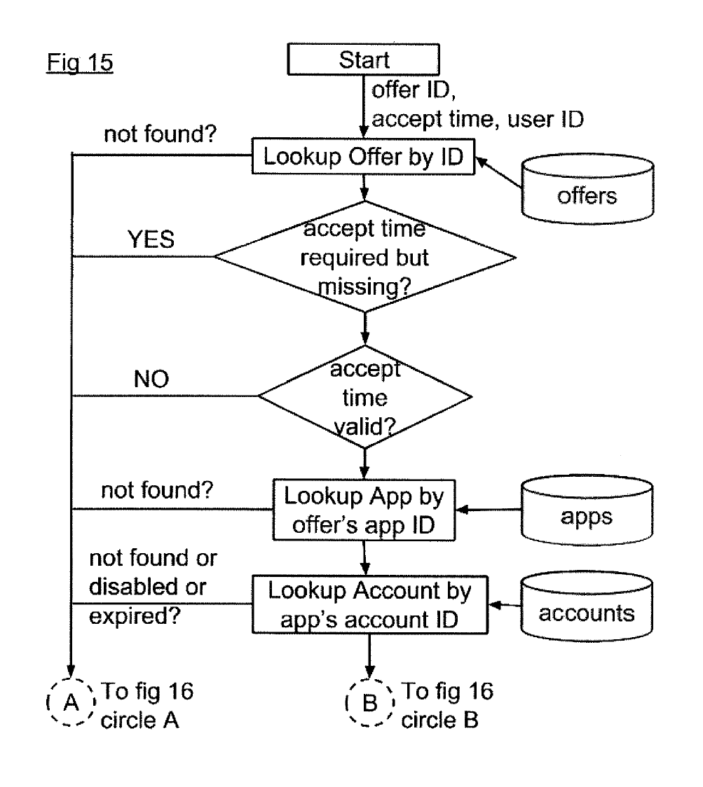

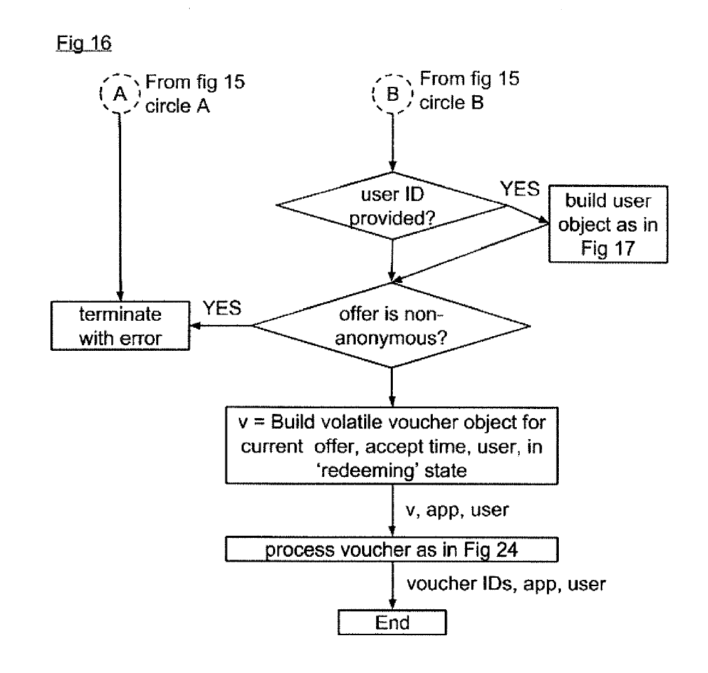

In step 1401, the notification typically includes some or all of the following elements:
a. Content Offer ID which was previously, during the Offer Definition process, incorporated into the Tracking Provider configuration or the Content Tracking Link, for storage by the Tracking Provider
b. End User Identity
c. End User Acceptance time—the time the user accepted (clicked on) the voucher
   1402. A preparation request is issued by the Advertiser's app, typically comprising some or all of:
   a. Content Offer ID, obtained from the Tracking Provider in step 1 of FIG. 5
   b. End User Identity, obtained from the Tracking Provider in step 1 of FIG. 5
   c. End User Acceptance time, obtained from the Tracking Provider in step 1 of FIG. 5
   1403. A processor performs a “Preparation algorithm” including, typically, some or all of the following functionalities: a request to prepare a voucher for redemption is passed to the system, a validation process takes place, and a list of redeemable vouchers are returned to the client. A suitable method for performing step 1403 is illustrated in FIGS. 15-16. Some or all of the following steps, suitably ordered e.g. as per below, may be performed:
   a. Input of the Content Offer ID, End User Identifier, End User Acceptance Time e.g. as described herein with reference to FIG. 5 step 1
   b. Lookup of the Content Offer associated with the given Content Offer ID
   c. Terminate with error if the Content Offer is not found
   d. Validating the syntax of the End User Acceptance Time if exists
   e. Optionally terminate with error if the Acceptance Time is not provided, as some Tracking Providers cannot send this information
   f. Lookup of the App owning with the Content Offer as found
   g. Terminate with error if the App is not found
   h. Lookup of the Account owning the found App
   i. Terminate with error if the Account is not found
   j. Terminate with error if the Account is not enabled—could occur if the system administrator has decided to lock the account or the owner of the account did not activate it within a predefined configurable time since the time of account creation
   k. Building of a device or user object, containing the End User Identifier, e.g. as per FIG. 16. Some or all of the following steps may be performed, suitably ordered e.g. as follows:
i. Look up an existing persistent device or user object with the same End User Identifier, in the storage medium
ii. Build a new volatile device or user object with the given End User Identifier, in case no existing device or user object has been found in the storage medium
iii. Terminate with error if the End User Identity is not provided, assuming the Content Offer has not been defined anonymous.
   l. Prepare, e.g. as per FIG. 16, a volatile voucher object for the given Content Offer, with the given Acceptance Time, designated ‘v’ in subsequent figs as it gets passed around e.g. as per the method of FIGS. 24-25; some or all of the following operations may be employed, in any suitable order e.g. as shown in FIG. 24.
   m. Return the voucher codes that were successfully set to the ‘redeeming’ state along with their Content Offer's type and quantity, the App information such as App name and External ID, and the user or device object including any provided End User Identifier and the identifier's hashed derivatives such as, but not limited to, SHA1 or MD5, their lowercase and/or uppercase versions, with or without non-alphanumeric characters like hypens, colons, dots, etc.

Optionally, if a tracker is capable of providing at least one tracker-specific field that store/s user click time, the method includes accepting the field, and using the user click time in order to validate offer expiration based on advertiser settings. If the tracker is normally expected to provide a click time such that a missing click time is “unexpected”, the system typically issues an error upon missing click time. If, however, the tracker is known to omit click time, then typically, for this specific tracker use case, the system skips expiration, or at least defaults to click time of “now”.

It is appreciated that conventionally, an advertiser seeking to promote an app whose statistics are not sufficiently high might perform a/b testing of the ad, e.g. change visual parameters of the ad or try an interactive approach. According to certain embodiments of the present invention as opposed to conventional a/b testing of visual parameters, an advertiser may a/b test a new dimension of parameters of his ad, relating to the value of the offer to a user, e.g. try different amounts of gold coins, different types of currency or in-app items, perform more than one offering in a single ad (“pick your loot: a magic sword or a magic armor?”).

Referring again to step (l) above, step (l) may include, suitably ordered, some or all of the following operations:

Obtain all existing vouchers in the ‘redeeming’ state;
Add the new volatile voucher ‘v’ object to the list of existing vouchers;
Process each voucher in the list to prepare each voucher for redemption e.g. perform some or all of the steps of FIG. 25. Operations performed may include, suitably ordered, some or all of:
i. Obtain the Content Offer of the voucher from the storage medium
ii. Terminate with error if the Content Offer is not found
iii. Terminate with error if Accept Time is given and the Content Offer expiration period does not exceed the period between accept time and the current time
iv. If a device or user object do exist for this voucher, look up the voucher group if defined and verify max redemption per user limits typically including offer-level and group-level definitions.

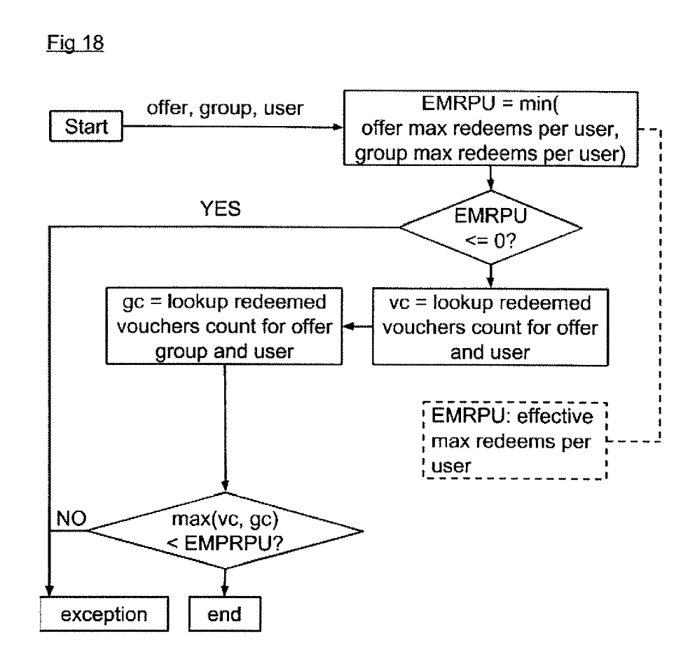

FIG. 18 is an example method for performing this step. Some or all of the steps of FIG. 18 may be performed, in any suitable order e.g. as shown. Then, verify min redemption interval limits typically including offer-level and group-level definitions.

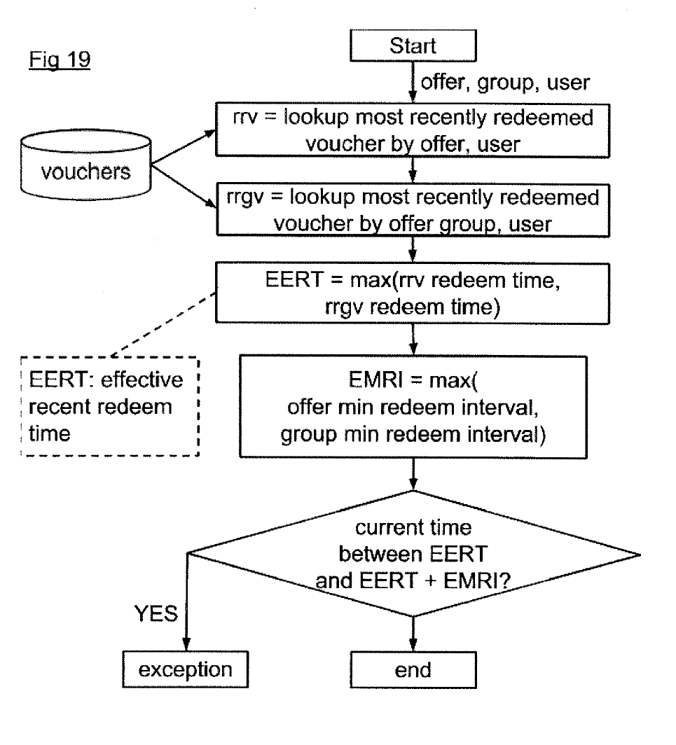

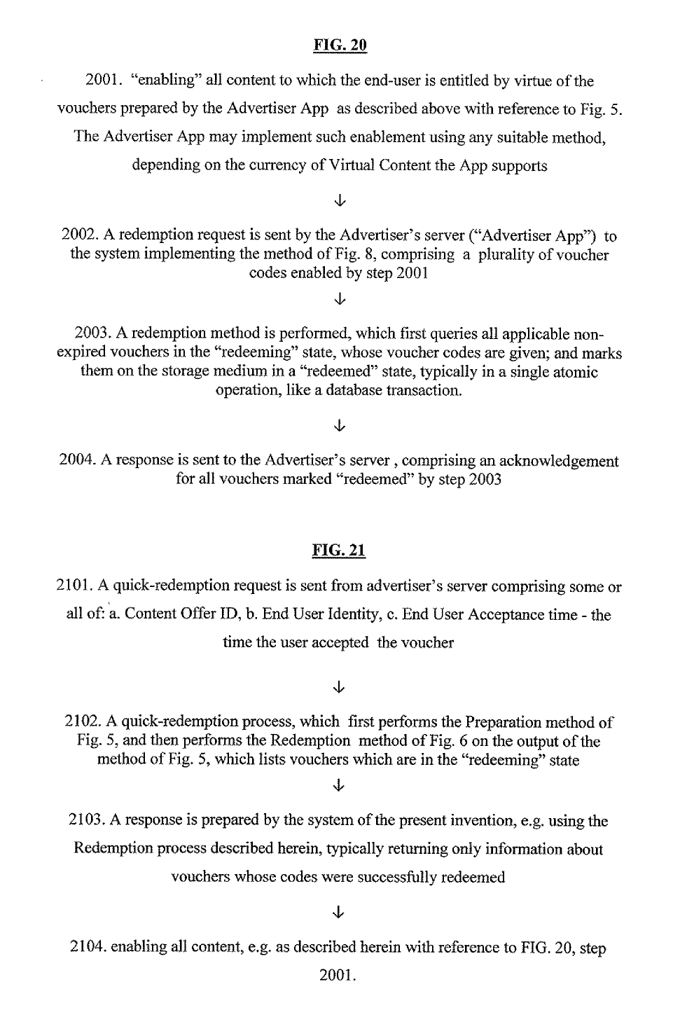

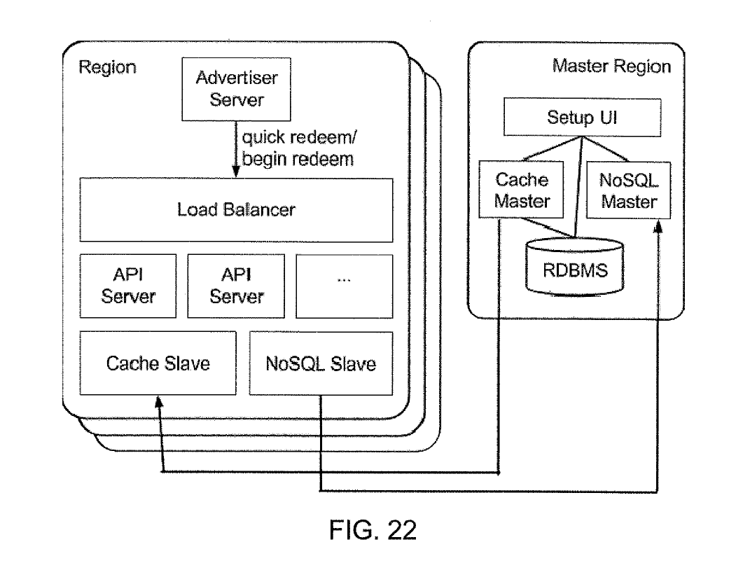

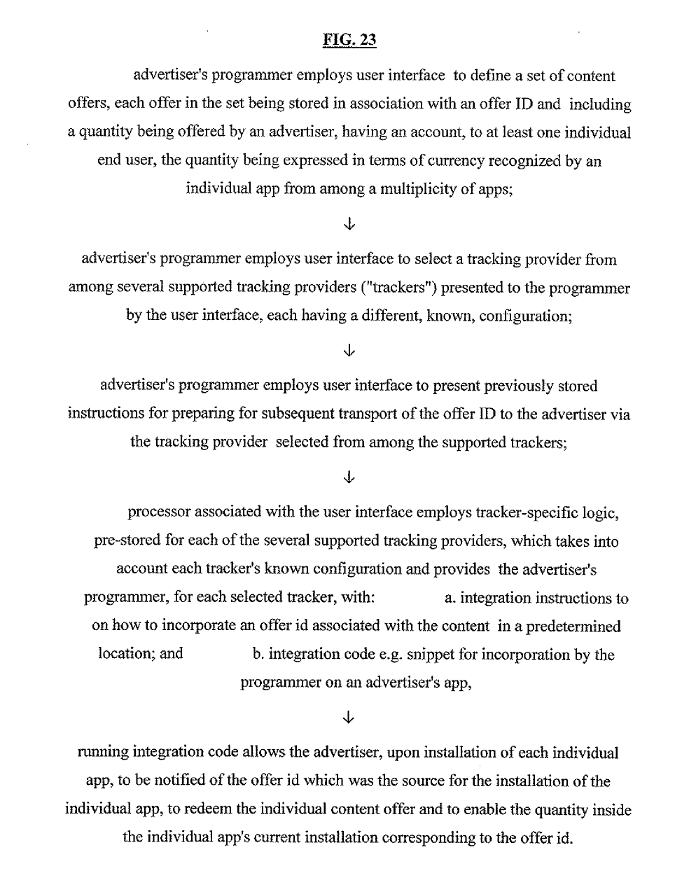

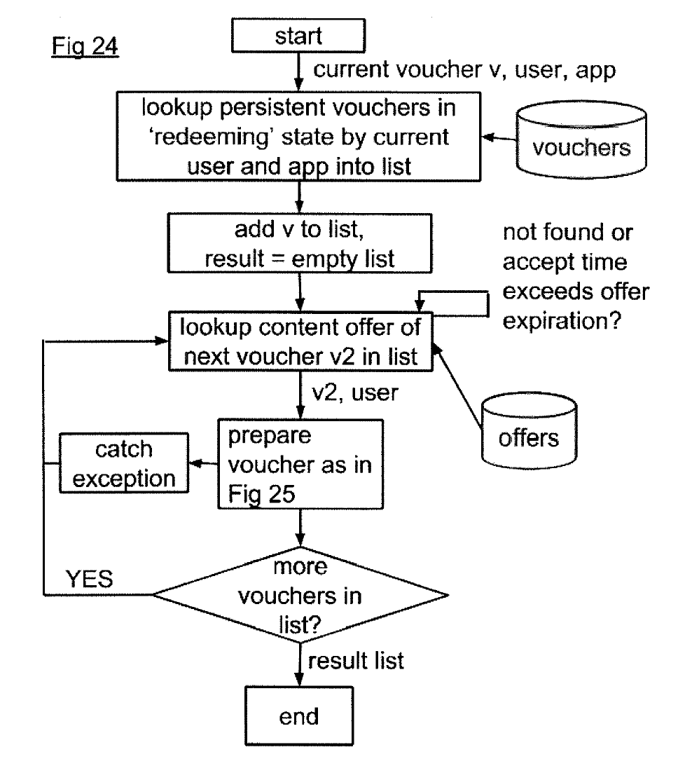

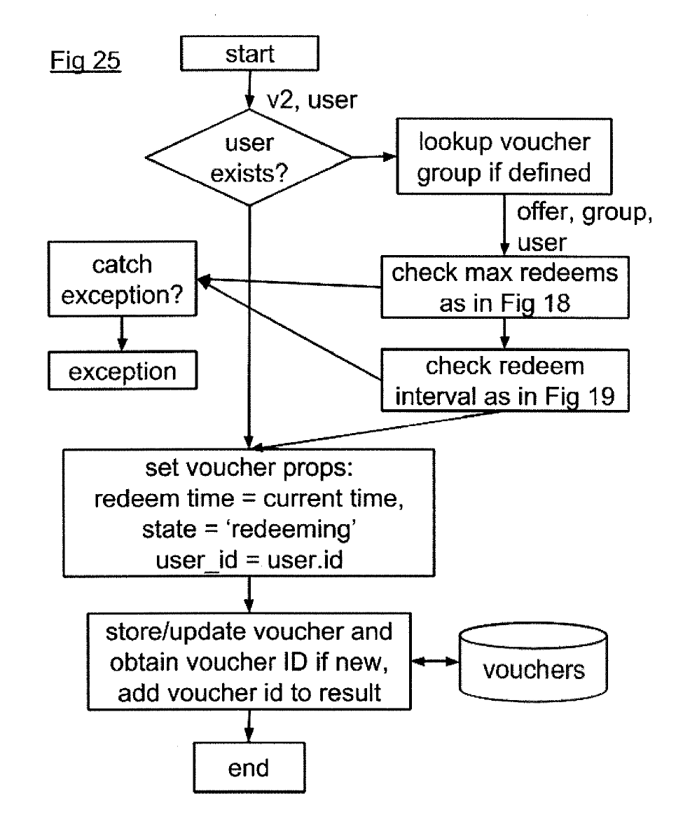

FIG. 19 is an example method for performing this step. Generally, some or all of the following steps may be included in the method of FIG. 19, in any suitable order e.g. as shown.

v. Set the voucher redeem time to the current time
vi. Set the voucher to ‘redeeming’ state. If the offer is non-anonymous, set the voucher's associated user id to that of the user/device object that was previously created or found based on the input user/device id.
vii. Store or update the voucher in storage medium to obtain a unique (within the system performing the method of FIG. 8) voucher redemption code.
18-1. Compute the Effective Max Redeems Per User (EMRPU) for this Content Offer as the minimum of the Content Offer's Max Redeems Per User and the Group's Max Redeems Per User:
18-2. Terminate with error if the Effective Max Redeems Per User is less or equal to zero
18-3. Query the number of redeemed vouchers of the Content Offer by the End User
18-4. Query the number of redeemed vouchers of the Content Offer's Group by the End User (if a Group has been defined)
18-5. Terminate with error if the maximum of the two last query results is greater or equal the Effective Max Redeems Per User

FIG. 19 typically includes some or all of the following operations, suitably ordered e.g. as shown:

a. Compute the Effective Recent Redeem Time as the “max redeem time” (maximal time interval) between the time of redemption of the most recently redeemed voucher of the End User and Content Offer, and between the time of redemption of the most recently redeemed voucher of the End User and Content Offer's Group
b. Compute the Effective Minimum Redeem Interval as the maximum between the Content Offer's Minimum Redeem Interval and the Content Offer Group's Minimum Redeem Interval
c. Terminate with error if the current time is within the time period starting the Effective Recent Redeem Time, ending after Effective Minimum Redeem Interval

The functionality described herein is typically invoked by the advertiser from suitable server-side points, e.g. via a suitable API.

If a tracking provider does not support these points, tracking provider-supported client-side points may be employed for integration e.g. as described in FIG. 5. Typically, the server side or client side components of the advertiser app attempts to redeem a voucher once a tracking provider notifies the advertiser app of a new install or reopen, identified by offer id and/or device/user id. It is appreciated that a trigger may be fired by an activation link and may also be tracker-mediated. For example (e.g. as per step 12-3 in FIG. 12), when a tracker is used for redirecting to the activation link, the click may still be mediated by the tracker, whereas the activation link may eventually cause the trigger to fire.

The offer id and/or device/user id is passed to the system of the present invention which is operative for generating the voucher and validating end-user's entitlement to the voucher, based on a configuration that the advertiser's programmer created when he originally defined the offer using the user interface shown and described herein. For example, validation might include checking for expiration, for the maximum number of vouchers an individual end-user may redeem, and so forth. If all logical conditions required for validation of voucher entitlement are true, the system typically generates a unique voucher, which is passed back to the process which initiated the redemption. The advertiser then enables the in-app content defined on the voucher for the individual end-user, as identified by the device/user id, Once the in-app content has been enabled, the advertiser “commits” e.g. informs the system which vouchers were successfully enabled, by sending their codes to the system e.g. as described herein with reference to FIG. 6.

It is appreciated that the device/user id is received for offers defined as non-anonymous, and, according to some embodiments, even for anonymous campaigns. In the latter case, the system avoids using or storing device/user id during validation to preserve anonymity. The tracker may pass to the system whatever it has, but if so, then for anonymous campaigns, some of the info (e.g. device/user id) is ignored, including any login that depends thereupon. FIG. 6 illustrates a voucher redemption apparatus for effecting Prepared Redemption (also termed herein “withdrawal”), wherein an Advertiser App redeems any vouchers, previously returned by the Preparation process. A suitable method of operation for the apparatus of FIG. 6 is shown in FIG. 20, which typically includes some or all of the following steps 2001, 2002, . . . , suitably ordered e.g. as follows:

2001. “enabling” all content to which the end-user is entitled by virtue of the vouchers prepared by the Advertiser App as described above with reference to FIG. 5. The Advertiser App may implement such enablement using any suitable method, depending on the currency of Virtual Content the App supports. For example,
a. if the voucher is for an additional unlocked game level, the App might implement the appropriate source code to actually unlock the next level that the end user did not yet reach, and make it available for him to use.
b. If the offer is for 5 swords (quantity=“5”; currency is “sword”), implementation might involve adding 5 sword objects to an end user's virtual item backpack, e.g. as stored in the app's virtual item database associated with the end-user's record, so when the user accesses his virtual backpack in the game, he finds 5 swords in the backpack.
2002. A redemption request is sent by the Advertiser's server (“Advertiser App”) to the system implementing the method of FIG. 8, comprising a plurality of voucher codes enabled by step 2001

The redemption request may also be sent by a client-side of the advertiser's app.

2003. A redemption method is performed, which first queries all applicable non-expired vouchers in the “redeeming” state, whose voucher codes are given; and marks them on the storage medium in a “redeemed” state, typically in a single atomic operation, like a database transaction.
2004. A response is sent to the Advertiser's server, comprising an acknowledgement for all vouchers marked “redeemed” by step 2003

FIG. 7 illustrates an apparatus for performing a Quick Redemption process, where an Advertiser App redeems any redeemable Vouchers without first initiating a Preparation process. The method of operation for FIG. 7 may include some or all of the following steps 2101, 2102, . . . , suitably ordered e.g. as shown in FIG. 21:

2101. A quick-redemption request is sent from advertiser's server to system of the present invention, comprising some or all of:

a. Content Offer ID which was previously defined by the Offer Definition process

b. End User Identity

c. End User Acceptance time—the time the user accepted the voucher

2102. A quick-redemption process, which first performs the Preparation method of FIG. 5, and then performs the Redemption method of FIG. 6 on the output of the method of FIG. 5, which lists vouchers which are in the “redeeming” state (e.g. because they have been presented by an end-user and verified).
2103. A response is prepared by the system of the present invention, e.g. using the Redemption process described herein, typically returning only information about vouchers whose codes were successfully redeemed
2104. enabling all content, e.g. as described herein with reference to FIG. 20, step 2001.

An example of deployment architecture suitable for implementing the preparation, redemption and quick redemption embodiments of FIG. 5, 6, 7 is illustrated in FIG. 22. Alternatively, any architecture which, typically, provides a high-scale and high-availability implementation, may be employed. The architecture of FIG. 22 may be varied as appropriate and typically includes some or all of the following characteristics i-v:
i. advertiser deploys a server in separate geographical regions, where most end users are located, to reduce API latency to a minimum
ii. system deploys a region-specific load balancer in the same region, to serve API calls, by diverting the calls to one or more region-specific API servers, so the load is distributed suitably between servers and also provides redundancy in case one of the servers is not responding
Iii. API server reads app and offers definitions through a region-specific cache slave, which is kept in sync with the master cache, representing an updated view of the apps and offers defined in an RDMBS (say) storage medium
iv. API server generates and reads/writes voucher information, device and user identities, from a region-specific NoSQL (say) slave server, which has its data periodically processed, mapped and transformed into a master NoSQL server for logging and reports, if needed
v. user interface for the advertiser is located in a single master region, which reads/writes apps and offers to the RDBMS storage medium. When writing, an item is also updated in the master cache. When reading, if an item does not exist in the master cache, the item may be read from the RDBMS, otherwise, the item's cached copy may be used.

According to certain embodiments, advertisers may select, e.g. via the user interface described herein, either the rapidly executable, easy to implement method of FIG. 7 or the “prepared” method of FIGS. 5-6 which is particularly suited for environments or apps with a likelihood of malfunction during enablement of voucher in-app content. A particular advantage of the method of FIG. 5-6 is handling of availability failures in the redemption process, e.g. in which enabling fails and/or times out within X (parameter) seconds. The method of FIGS. 5-6 ensures that the voucher is only marked as “redeemed” if the voucher was actually successfully enabled to the relevant end-user.

The “within X” parameter may be configurable in the system as a system-wide value, account-wide value, app-wide value, offer-specific value, or a combination thereof e.g. the maximum of all, or by order of precedence (say: offer takes precedence over app which takes precedence over account). Optionally, the advertiser may seek “incentivized traffic” by partnering with publisher/s who incentivize their own (publisher's) users to engage with the advertiser's ads. For example, a soccer game (publisher) might tell its end-user that “if you download this bingo game (advertiser), I am going to give you 20000 points to improve your existing soccer team”. The user engages with the advertiser only due to her or his interest in the soccer team—not due to interest in the bingo app. In contrast, the system of the present invention allows the advertiser (not the publisher) to attach value to an electronic ad by turning the ad into a voucher; this may add an additional dimension of data to the analytic platforms of publishers and/or tracking providers. For example, the advertiser may distribute 10 vouchers each offering 100-1000 gold/silver coins, or other virtual in-app value recognized in the advertiser's app (e.g. electronic game). Publishers may then use their own targeting and optimization functionalities to determine which of the 10 vouchers the advertiser has defined are best served to which of the publisher's users. For example, a tracking provider may find that female 30yo in the UK prefer gold coins, male 20yo in India prefer silver coins, and that offers of at least 600 coins brought more high-quality users than either 100 or 1000 coins. However, the new dimension of data provided by the system herein cannot be measured by the analytic tools of the tracker and therefore in the absence of the system of the present invention, the advertiser cannot make decisions on that basis. According to certain embodiments of the present invention, the system supports providing a new dimension of data to publishers, thereby facilitating publishers' targeting and optimization functionalities which may now be based on value, rather than just on conventional visual parameters.

It is appreciated that embodiments of the invention are useful in conjunction with a wide variety of publisher and tracking provider tools, architectures and feature sets which may be used as infrastructure to support the system shown and described herein.

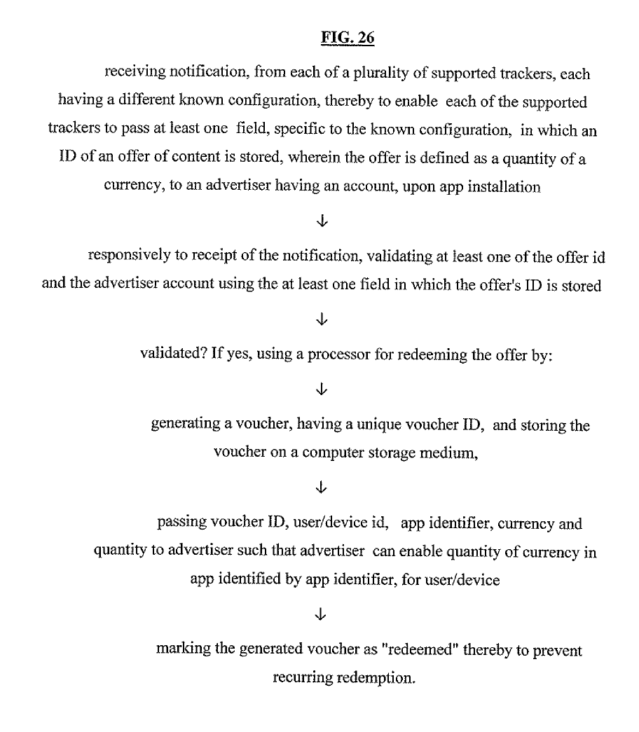

Referring now to FIGS. 27-35:

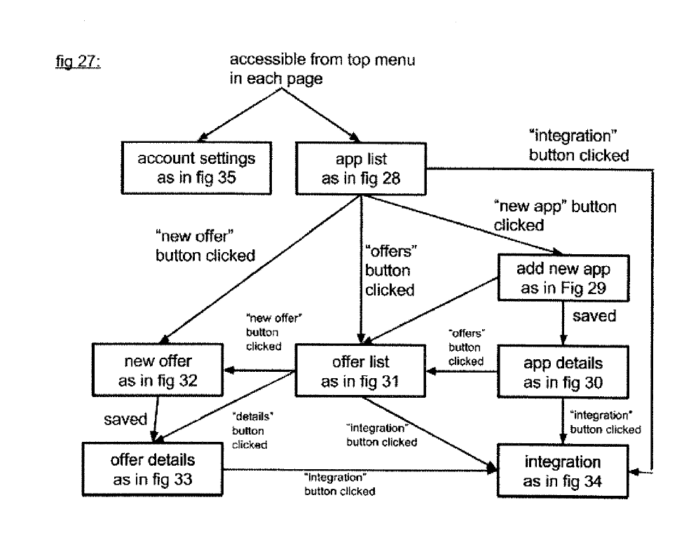

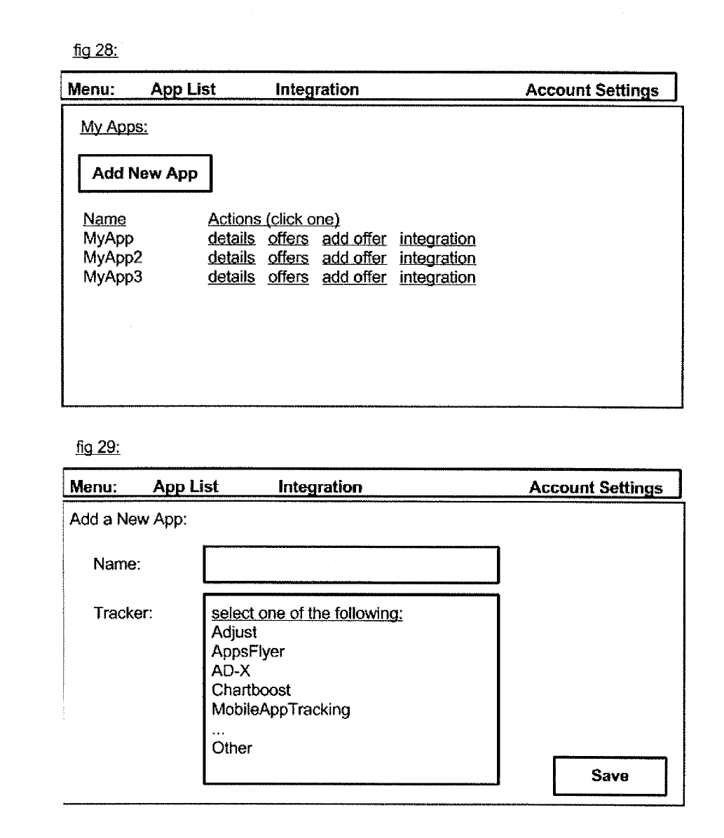

FIG. 27 describes an example flow for the user interface described herein, showing which pages may exist, and which user action, performed within each page, might lead to other page/s. FIGS. 28-35 illustrate example screen shots of web pages some or all of which may be useful in implementing the user interface described herein, typically in conjunction with conventional pages and flows such as login, signup, reset password. The “user” is typically the advertiser's programmer rather than the end-user.

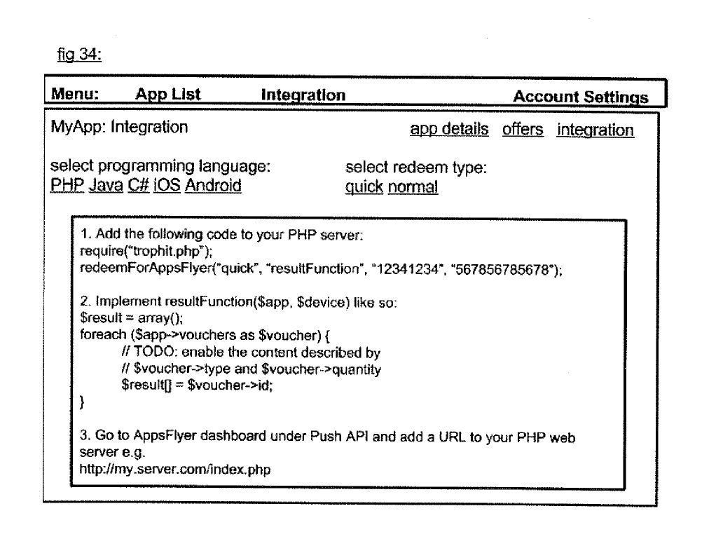

Typically, all pages may include a top (say) navigation menu, allowing access to some of the pages, such as app list and account settings. The “integration” top menu button typically leads the advertiser to the integration page as in FIG. 34, but the instructions there are typically account-side (for all apps), contrary to the app-specific instructions available by using the “integration” button in the “app list page” next to each app as in FIG. 28.

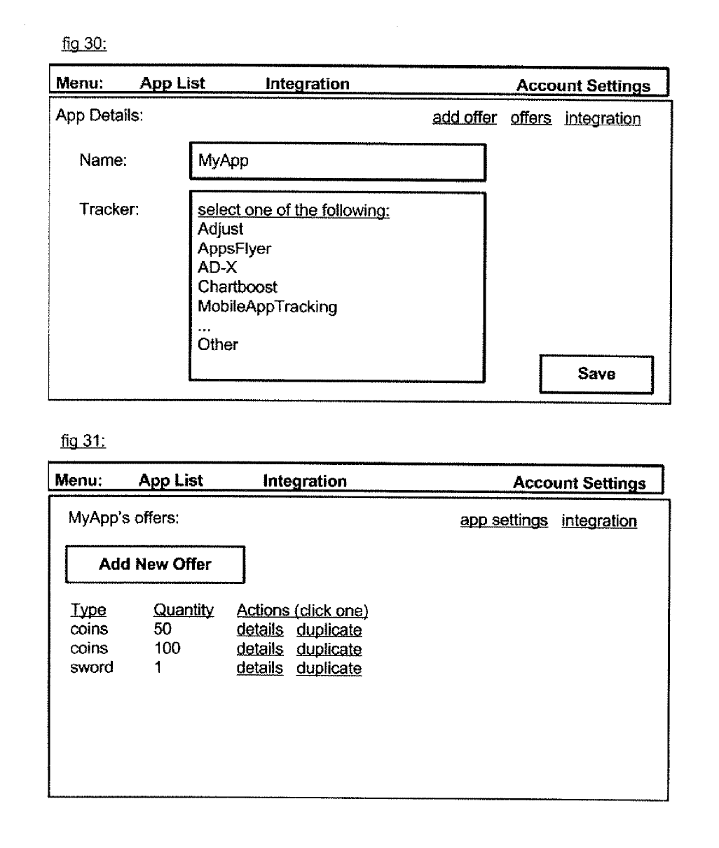

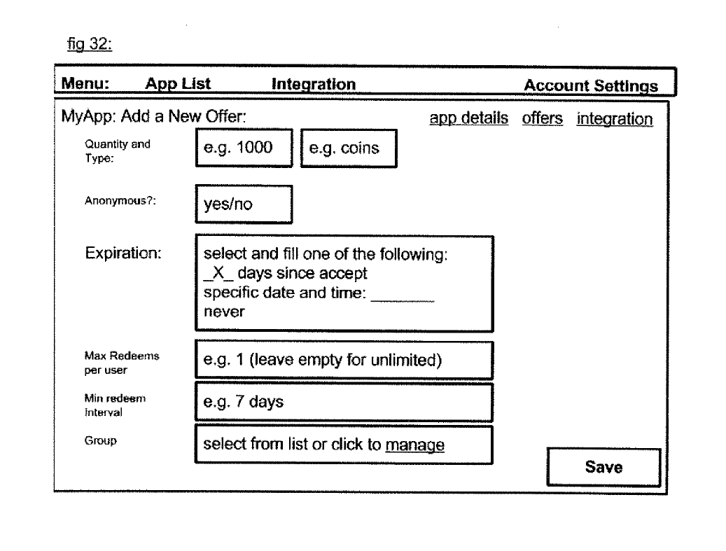

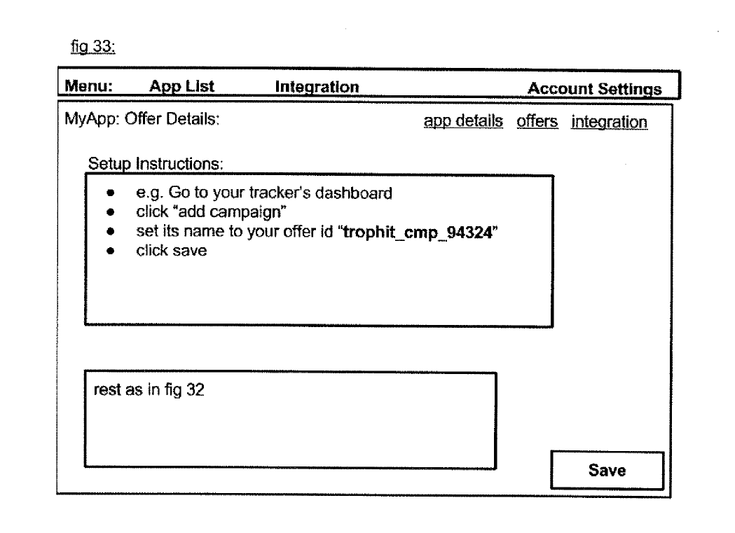

FIG. 28 is an app list page, typically allowing the advertiser's programmer (user) to perform some or all of the following operations:
see a list of her or his apps
create a new app e.g. using the “add new app” button which typically leads to the “add new app page” e.g. as in FIG. 29
edit the details of an existing app, e.g. using the “details” button next to each app, which typically leads to the “app details” page e.g. as in FIG. 30
access the list of offers for an existing app, e.g. using the “offers” button next to each app which typically leads to the “offer list” page e.g. as in FIG. 31
add a new offer for an existing app e.g. by using the “add offer” button next to each app, which typically leads to the “new offer” page as in FIG. 32
access integration code snippets e.g. by using the “integration” button next to each app, which typically leads to the integration page as in FIG. 34

FIG. 29, the “add new app” page, typically allows the advertiser to add an app to her or his account by specifying the app name, selecting the app's tracker and clicking the “save” button which stores the app details in association with the account of the advertiser that is currently logged in; the app object's account ID may be set to the current account ID. Selecting “other tracker” may cause the advertiser to later receive generic information on how to integrate with the advertiser's tracker, typically assuming that the tracker meets certain requirements e.g. as described herein in detail. FIG. 30 is similar to FIG. 29, however opens with the details of an existing app rather than with empty fields and/or has a top (say) sub navigation menu to perform app-related actions such as but not limited to “add offer”, “offers” and “integration” which may have the same functionality as the corresponding buttons in the app list page as in FIG. 28.

FIG. 31 is an app's offer list page, allowing the advertiser's programmer to perform some or all of the following operations:
see a list of her or his offers for a particular app
create a new offer e.g. using the “add new offer” button which typically leads to the “add new offer” page as in FIG. 32
edit the details of an existing offer, e.g. using the “details” button next to each offer, which typically leads to the “offer details” page as in FIG. 30
duplicate an existing offer, e.g. using the “duplicate” button next to each offer, which typically leads to the “add new offer” page as in FIG. 32 while passing the selected offer id along to the page at click time.
perform app-related actions such as “app settings” and “integration”, e.g. using a top sub navigation menu which may be used just as corresponding buttons in the app list page of FIG. 28 are used.

FIG. 32, the “add new offer” page, typically allows the advertiser's programmer to perform some or all of the following operations: to add a new offer for the currently selected app, to state given type and quality, to indicate whether or not the offer is anonymous, to indicate—for each generated voucher—voucher aspects or attributes such as but not limited to the voucher's expiration, maximum number of allowable redemptions per user, minimum redemption interval between two vouchers associated with this (the same) offer by the same user, an optional offer group, and finally clicking “save”.

If an advertiser wishes to add a group or edit an existing one, his programmer typically clicks on a “manage” button next to the group field to see a list of groups, or add new groups. For each new group, the programmer may open the group's details in a new dialog, allowing the programmer to edit the group's name, and to configure, say, maximum number of redemptions permissible per user and/or minimum redeem interval of the group.

Typically, a top sub navigation menu is provided to perform app-related actions such as “app details” and “integration” e.g. just as corresponding buttons in the app list page as in FIG. 28 are used, as well as an “offers” button which typically leads to the current app's offer list page as in FIG. 31.

FIG. 33, the offer details page, may be similar to FIG. 32, but may also include an additional “setup instructions” section, describing, based on the offer's app tracker, how to integrate the offer's id into the tracker's configuration.

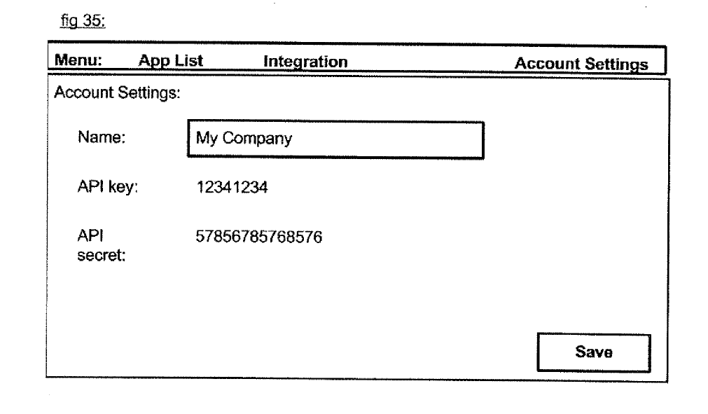

FIG. 34, the integration page, typically displays ready-to-deploy code snippets for the advertiser's client/server side, typically depending on one or more of: the selected app's tracker, account security settings as in FIG. 35, selected programming language and type of redemption required (quick redemption, as in FIG. 7, or prepared redemption, as in FIGS. 5-6). The illustrated embodiment, for example, is configured for a conceptual AppsFlyer tracker, for PHP programming language and for quick redemption.

The integration page of FIG. 34 typically accepts an optional app id as input. If provided, the instructions may appear for a particular app. Otherwise, the instructions will appear for all apps in the current account. If the apps in the account are all using the same tracker, the code will look as if a single app has been selected, with the exception of an optional code section showing (say) a placeholder switch statement inside resultFunction with app names such as:

```
For each ($app->vouchers as $voucher) { switch ($app->name) {
      case “MyApp”: break; // TODO
      case “MyApp2”: break; // TODO
}}
```

If the apps in the account are using more than one tracker, separate instructions for each tracker will appear.

FIG. 35, the account settings, allows the advertiser's programmer to perform some or all of the following operations:
show the advertiser's account settings
edit the account name
see the account's API security settings (read only) as used for integration e.g. as in FIG. 34
save changes to the editable sections of the page.

It is appreciated that terminology such as “mandatory”, “required”, “need” and “must” refer to implementation choices made within the context of a particular implementation or application described herewithin for clarity and are not intended to be limiting since in an alternative implementation, the same elements might be defined as not mandatory and not required or might even be eliminated altogether.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware and/or firmware, if desired, using conventional techniques, and vice-versa. Each module or component may be centralized in a single location or distributed over several locations.

Included in the scope of the present disclosure, inter alia, are electromagnetic signals in accordance with the description herein. These may carry computer-readable instructions for performing any or all of the steps or operations of any of the methods shown and described herein, in any suitable order including simultaneous performance of suitable groups of steps as appropriate; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including at least one processor and/or cooperating input device and/or output device and operative to perform e.g. in software any steps shown and described herein; information storage devices or physical records, such as disks or hard drives, causing at least one computer or other device to be configured so as to carry out any or all of the steps of any of the methods shown and described herein, in any suitable order; at least one program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; at least one processor configured to perform any combination of the described steps or to execute any combination of the described modules; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any step or functionality described herein may be wholly or partially computer-implemented e.g. by one or more processors. The invention shown and described herein may include (a) using a computerized method to identify a solution to any of the problems or for any of the objectives described herein, the solution optionally includes at least one of a decision, an action, a product, a service or any other information described herein that impacts, in a positive manner, a problem or objectives described herein; and (b) outputting the solution.

The system may if desired be implemented as a web-based system employing software, computers, routers and telecommunications equipment as appropriate. Any suitable deployment may be employed to provide functionalities e.g. software functionalities shown and described herein. For example, a server may store certain applications, for download to clients, which are executed at the client side, the server side serving only as a storehouse. Some or all functionalities e.g. software functionalities shown and described herein may be deployed in a cloud environment. Clients e.g. mobile communication devices such as smartphones may be operatively associated with but external to the cloud.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention, including method steps, which are described in the context of separate embodiments may also be provided in combination in a single embodiment. For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly, although not limited to, those described in the Background section or in publications mentioned therein.

Conversely, features of the invention, including method steps, which are described for brevity in the context of a single embodiment or in a certain order may be provided separately or in any suitable subcombination, including with features known in the art (particularly although not limited to those described in the Background section or in publications mentioned therein) or in a different order. “e.g.” is used herein in the sense of a specific example which is not intended to be limiting. Each method may comprise some or all of the steps illustrated or described, suitably ordered e.g. as illustrated or described herein.

Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, PDA, Blackberry GPRS, Satellite including GPS, or other mobile delivery. It is appreciated that in the description and drawings shown and described herein, functionalities described or illustrated as systems and sub-units thereof can also be provided as methods and steps therewithin, and functionalities described or illustrated as methods and steps therewithin can also be provided as systems and sub-units thereof. The scale used to illustrate various elements in the drawings is merely exemplary and/or appropriate for clarity of presentation and is not intended to be limiting.

1. A computer-implemented offer redemption process including:
receiving notification, from each of a plurality of supported trackers, each having a different known configuration, thereby to enable each of said supported trackers to pass at least one field, specific to said known configuration, in which an ID of an offer of content is stored, wherein said offer is defined as a quantity of a currency, to an advertiser having an account, upon app installation;
responsively to receipt of said notification, validating at least one of said offer id and said advertiser account using said at least one field in which said offer's ID is stored; and
if validated, using a processor for redeeming the offer including:
generating a voucher, having a unique voucher ID, and storing said voucher on a computer storage medium,
passing the voucher ID, a user/device id, an app identifier, said currency and said quantity to the advertiser such that said advertiser can enable said quantity of said currency in an app identified by said app identifier, for said user/device, and
marking the generated voucher as “redeemed” thereby to prevent recurring redemption.

2. A computer-implemented method facilitating generation by an advertiser's programmer, of computerized content offers to be made to a population of end-users, the method comprising:
providing a user interface enabling an advertiser's programmer:
i. to define a set of content offers, each offer in said set being stored in association with an offer ID and including a quantity being offered by an advertiser, having an account, to at least one individual end user, the quantity being expressed in terms of currency recognized by an individual app from among a multiplicity of apps;
ii. to select a tracking provider from among several supported tracking providers (“trackers”) presented to the programmer by the user interface, each having a different, known, configuration; and
iii. to present previously stored instructions for preparing for subsequent transport of the offer ID to the advertiser via the tracking provider selected from among said supported trackers;
wherein a processor associated with the user interface employs tracker-specific logic, pre-stored for each of said several supported tracking providers, which takes into account each tracker's known configuration and provides the advertiser's programmer, for each selected tracker, with the following:
a. integration instructions to on how to incorporate an offer id associated with said content in a predetermined location; and
b. integration code e.g. snippet for incorporation by the programmer on an advertiser's app, wherein said code is operative, when run on a processor, to cause the advertiser, upon installation of each individual app, to be notified of the offer id which was the source for the installation of said individual app, to redeem said individual content offer and to enable said quantity inside said individual app's current installation corresponding to said offer id.

3. A process according to claim 1 which includes receiving, during set-up, from an advertiser's programmer via a user interface, a definition of at least one redemption limit including a minimum time interval that must separate any two redemptions by the same end-user for an individual content-offer (“minimum redemption interval”) and validating said redemption limit during redemption by verifying that said minimum redemption interval is satisfied.

4. A process according to claim 2 wherein the user interface enables an advertiser's programmer to optionally define at least one per-end-user redemption limit, to be enforced during redemption of said content offer.

5. A process according to claim 1 wherein a user's click time is used to generate vouchers.

6. A process according to claim 2 wherein the user interface enables an advertiser's programmer to optionally define at least one per-offer-group redemption limit (“constraint”), to be enforced during redemption of said content offer by imposing said redemption limit on all vouchers associated with content offers belonging to said offer-group.

7. A process according to claim 1 wherein a device/user identifier is used to generate vouchers.

8. A method according to claim 1 and also comprising receiving, from said tracker, at least one tracker-specific field that store/s device and/or user identifier for at least one offer,
and using said device/user identifier in order to perform at least one of:
validating per-user limits for at least one non-anonymous offer;
validating group-level limits for at least one non-anonymous offer; and
associating a user or device to the voucher.

9. A method according to claim 1 and wherein, if a tracker is capable of providing at least one tracker-specific field that store/s user click time, the method includes accepting said field, and using said user click time in order to validate offer expiration based on advertiser settings.

10. A method according to claim 8 and also comprising storing said device/user identifier for vouchers defined as non-anonymous and not for vouchers defined as anonymous.

11. A method according to claim 4 and also comprising enforcing at least one redemption limit which comprises a limit on time.

12. A method according to claim 1 wherein subsequently, for each app installation, each tracker, despite configuration differences between itself and other trackers, is also able to notify the advertiser about at least one of: user click times and device/user identifiers.

13. A method according to claim 6 and also comprising enforcing at least one redemption limit which comprises a limit on time.

14. A process according to claim 3 wherein said interval is defined once for an entire offer-group which includes a plurality of content offers and said minimum redemption interval is subsequently validated during redemption of all of said plurality of content offers.

15. A process according to claim 1 which includes receiving, during set-up, from an advertiser's programmer via a user interface, a definition of a voucher's expiration time and validating said voucher's expiration time during redemption.

16. A process according to claim 1 wherein said voucher is stored, during redemption, in association with at least one of: user click time, device/user identifier, user/device ID.

17. A process according to claim 1 which includes determining the number of redemptions which occurred over a given time period for a particular user/device, for an individual offer.

18. A method according to claim 1 wherein said notification is provided by a tracker and wherein said field comprises a tracker-specific field.

19. A process according to claim 1 wherein said validating includes verifying that at least one end-user did not exceed a predetermined logical combination of a per-offer redemption limit and a per-group redemption limit.

20. A method according to claim 1 wherein said notification is provided by an activation link and wherein said field comprises an activation link parameter field.

21. A method according to claim 1 wherein said redeeming occurs without overriding original tracking links (URLs), thereby reducing click latency caused by an end-user waiting with an empty Internet browser, by routing each end-user, who has accepted said offer, directly to the original tracking link rather than routing the end-user to said original link indirectly, via another server.

22. A method according to claim 1 and also comprising storing, and reporting to an advertiser, an indication of all voucher ids whose vouchers were successfully redeemed.

23. A method according to claim 4 and also comprising enforcing at least one redemption limit which comprises a limit on quantity.

24. A process according to claim 1 which includes determining the number of redemptions which occurred over a given time period for a particular user/device, for a group of offers.

25. A computer program product, comprising a non-transitory tangible computer readable medium having computer readable program code embodied therein, said computer readable program code adapted to be executed to implement an offer redemption process including:
receiving notification, from each of a plurality of supported trackers, each having a different known configuration, thereby to enable each of said supported trackers to pass at least one field, specific to said known configuration, in which an ID of an offer of content is stored, wherein said offer is defined as a quantity of a currency, to an advertiser having an account, upon app installation;
responsively to receipt of said notification, validating at least one of said offer id and said advertiser account using said at least one field in which said offer's ID is stored; and
if validated, using a processor for redeeming the offer including:
generating a voucher, having a unique voucher ID, and storing said voucher on a computer storage medium,
passing the voucher ID, a user/device id, an app identifier, said currency and said quantity to the advertiser such that said advertiser can enable said quantity of said currency in an app identified by said app identifier, for said user/device, and
marking the generated voucher as “redeemed” thereby to prevent recurring redemption.

26. A method according to claim 2 wherein said previously stored instructions prompt to request at least one App Tracking URL from said selected Tracking Provider thereby to enable said App Tracking URL to be passed, subsequently, to an advertiser-selected e-content publisher from among a population of e-content publishers, for future serving, as part of an ad, to the end users of the selected publisher, wherein said predetermined location is disposed in a known value field in the known configuration of said selected tracker,
wherein, for each subsequent app installation resulting from a “source” offer from among said set of content offers, the offer ID and ad click time are routed to said predetermined location in said known configuration.

27. A method according to claim 2 wherein said previously stored instructions prompt to configure an activation link for the app of said content offer thereby to enable said activation link to be redirected, subsequently, through said tracking URL, by an advertiser-selected e-content publisher, as part of an ad, to end users of the selected publisher,
wherein said predetermined location is disposed in an activation link in the known configuration of said selected tracker, and
wherein, for each app installation resulting from a “source” offer from among said set of content offers, the offer id is transported via said activation link.

28. A method according to claim 26 wherein, for each said subsequent app installation, each end user, by invoking the App Tracking URL, navigating to the app download page, and downloading (if missing) and opening the app, triggers a notification to the advertiser of the offer id which was the source offer from which said app installation resulted.

29. A method according to claim 27 and wherein, for each subsequent app installation, each end user, by invoking the App Tracking URL, is then redirected by the selected tracker to said activation link, and wherein opening the app then triggers a notification to the advertiser of the offer id of a content offer which was the source offer from which said app installation resulted.

30. A process according to claim 15 which validates expiration based on a preconfigured point in time.

31. A process according to claim 15 which validates expiration if a preconfigured time-period has elapsed since an end-user accepted a content offer corresponding to said voucher.
